(19) United States
(12) Patent Application Publication
(10) Pub. No.: US 2026/0289090 A1
(43) Pub. Date: Sep. 24, 2026

(54) SYSTEM

(71) Applicant: SoftBank Group Corp., Tokyo (JP)

(72) Inventor: Hiroyuki HAYAKAWA, Tokyo (JP)

(73) Assignee: SoftBank Group Corp., Tokyo (JP)

(21) Appl. No.: 19/567,443

(22) Filed: Mar. 16, 2026

(30) Foreign Application Priority Data
Mar. 19, 2025 (JP) 2025-045262

(51) Int. Cl. G06F 40/166; G06N 3/0475; G10L 15/22; G10L 25/78; H04L 51/02

(52) U.S. Cl. CPC G06F 40/166; G06N 3/0475; G10L 15/22; G10L 25/78; H04L 51/02; G10L 2015/225; G10L 2025/783

(57) ABSTRACT

A system comprising a processor, wherein the processor is configured to: acquire a sports broadcast video, extract an audio signal from the sports broadcast video, and convert the extracted audio signal into text by using a speech recognition technique, detect a sudden change in volume in the audio signal and identify a highlight portion of a game based on the detected sudden change in volume, obtain game information from an external database, and generate a prompt sentence for instructing a generative AI model to generate a text based on the obtained game information and the identified highlight portion of the game.

### CROSS-REFERENCE TO RELATED APPLICATION

This application is based on and claims priority under 35 USC 119 from Japanese Patent Application No. 2025-045262 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional techniques for generating social media texts related to sports events largely depend on manual operations or simple rule-based systems. In particular, an operator typically watches a sports broadcast, subjectively determines exciting moments of a game, manually collects game information such as scores and player names from external sources, and then manually creates and posts social media texts. This manual workflow is time-consuming, labor-intensive, and prone to human error and latency, and thus is not suitable for real-time distribution of content synchronized with live sports events. Furthermore, existing automated systems that merely monitor scores or basic game events lack the ability to capture audience excitement reflected in audio signals and commentator reactions, and therefore cannot accurately identify highlight portions of a game. In addition, known systems do not adequately reflect the emotional state or preference of a user in the generated text, which may result in low user engagement and insufficient personalization of the content. Accordingly, there is a demand for a system capable of automatically acquiring sports broadcast video, extracting and analyzing audio to detect highlight portions based on sudden volume changes, obtaining detailed game information from an external database, and generating prompt sentences and texts for a generative AI model in real time, while also enabling adaptation to a recognized emotion of a user.

### SUMMARY

In order to solve the above-described problems, according to one aspect, there is provided a system comprising a processor, wherein the processor is configured to acquire a sports broadcast video, extract an audio signal from the sports broadcast video, and convert the extracted audio signal into text by using a speech recognition technique, detect a sudden change in volume in the audio signal and identify a highlight portion of a game based on the detected sudden change in volume, obtain game information from an external database, and generate a prompt sentence for instructing a generative AI model to generate a text based on the obtained game information and the identified highlight portion of the game. According to another aspect, the processor is configured to recognize an emotion of a user and, based on the recognized emotion, generate the prompt sentence for instructing the generative AI model to generate the text, thereby enabling personalization of the generated text in accordance with the user's emotional state. According to still another aspect, the processor is configured to cause the generative AI model to generate the text based on the prompt sentence, and distribute the generated text in real time, so that social media content synchronized with highlight portions of the game can be automatically provided with reduced delay and reduced manual workload.

The term “system” refers to an arrangement of one or more hardware and/or software components that cooperate to execute the processing described in the present disclosure, including at least one processor and any necessary memory, interfaces, and communication elements.

The term “processor” refers to any device or circuitry capable of executing instructions, such as a central processing unit (CPU), graphics processing unit (GPU), digital signal processor (DSP), microcontroller, or a combination of hardware logic and software modules.

The term “sports broadcast video” refers to a video signal or video content that depicts a sports event and is transmitted or recorded via television, internet streaming, or any other broadcasting or distribution medium.

The term “audio signal” refers to sound data associated with the sports broadcast video, including commentator voice, crowd noise, and other audio components, represented in an analog or digital form suitable for processing.

The term “speech recognition technique” refers to any algorithm, model, or service that converts spoken language contained in the audio signal into machine-readable text, including cloud-based APIs and locally executed recognition engines.

The term “text” refers to character-based data obtained by converting speech or other information into a sequence of characters or symbols that can be processed, stored, displayed, or transmitted by the system.

The term “sudden change in volume” refers to a rapid variation in the amplitude or loudness level of the audio signal that exceeds a predetermined threshold in magnitude or rate of change within a given time interval.

The term “highlight portion of a game” refers to a time segment within the sports event that is determined, based on one or more criteria such as sudden changes in volume or associated events, to be particularly exciting, significant, or noteworthy for viewers.

The term “external database” refers to any data storage system or service, located outside the processor or the local device, that provides game-related information through an interface or communication network.

The term “game information” refers to data related to a sports event, including but not limited to scores, teams, players, event types, event times, and other metadata relevant to describing or analyzing the game.

The term “prompt sentence” refers to a textual instruction or set of instructions that is generated by the processor and provided as input to a generative AI model in order to control or guide the content, style, or structure of a text to be generated.

The term “generative AI model” refers to an artificial intelligence model, such as a neural network-based language model, that is capable of generating text in response to an input prompt, based on learned patterns from training data.

The term “user” refers to a human operator or viewer who interacts with the system directly or indirectly, and whose preferences or emotional state may be taken into account in generating text.

The term “emotion of a user” refers to an affective state or sentiment of the user, such as excitement, joy, disappointment, or neutrality, which is recognized or inferred by the system through explicit input, sensor data, or analysis of user behavior.

The term “recognize an emotion” refers to a process in which the system determines, estimates, or classifies the emotion of a user based on one or more inputs, including but not limited to physiological signals, facial expressions, voice features, or interaction patterns.

The term “generate the text” refers to the operation in which the generative AI model, in response to a prompt sentence, produces a sequence of characters or words that form a natural-language expression suitable for presentation or distribution.

The term “distribute the generated text in real time” refers to transmitting or making available the text generated by the generative AI model to external systems or users with a delay that is sufficiently small relative to the progress of the sports event, such that the text is perceived as substantially synchronized with the corresponding highlight portion.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

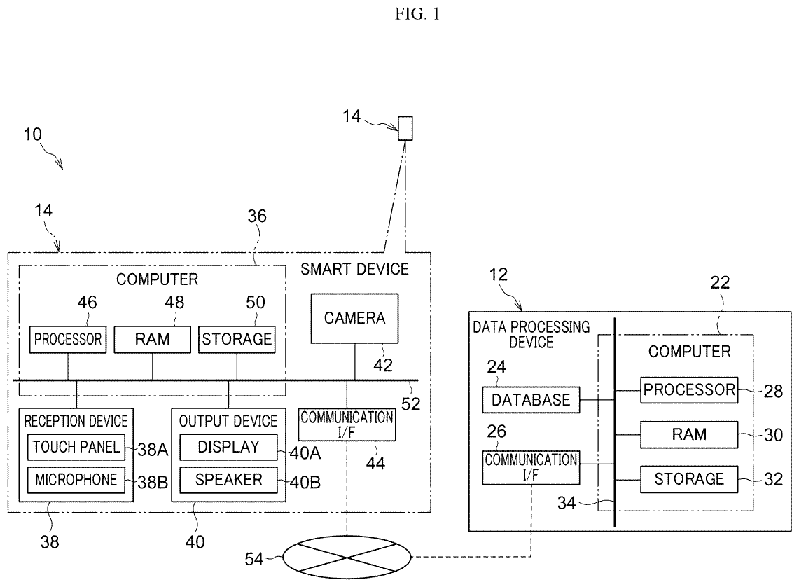

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

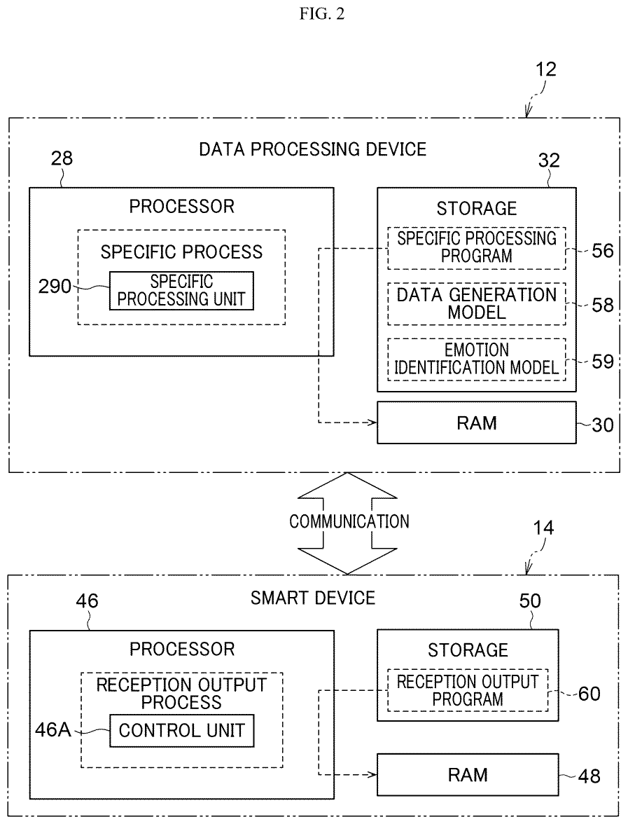

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional sports video distribution systems mainly focus on transporting audiovisual data from a content source to a user terminal with minimal latency and acceptable visual quality. Although such systems may provide basic metadata, they typically treat the audio commentary and external match data as passive by-products and do not deeply integrate these data streams into the core media-processing pipeline. As a result, existing systems have several technical limitations from the standpoint of computer technology. First, conventional systems generally lack an automated, low-latency mechanism in the server to detect and characterize “excitement events” within a live sports stream based on joint analysis of audio signals and recognized speech content. Audio is usually processed only for decoding and playback. Detection of highlights is often performed offline or manually, which prevents the server from dynamically adapting its processing and network behavior in response to real-time events. This leads to inefficient use of processing resources and network bandwidth, and prevents the server from optimizing the timing and content of supplementary information delivered to the terminal.

Second, conventional systems do not tightly couple external structured match data, such as scores, team information, and participant information, with time-aligned textual data derived from live commentary. In many architectures, such structured data is fetched and displayed as separate overlays or web elements, with loose synchronization to the underlying media stream. This separation makes it difficult for the server to reason about the semantic context of specific time segments in the video, and limits the ability to perform context-aware generation of descriptions or summaries. Consequently, the server cannot effectively leverage modern generative AI models as part of the real-time media-processing pipeline.

Third, in existing systems, prompt sentences for generative AI models are typically handcrafted, static, or prepared in an application layer that is decoupled from the timing and structure of the audiovisual data. The server does not systematically construct prompts based on machine-understandable, structured representations that capture the relationship between excitement events, recognized speech, and external match data. This architecture prevents the generative AI model from being used as a tightly integrated media-processing component, and the generated text often lacks precise temporal alignment and technical consistency with the live stream.

Fourth, existing systems do not provide a server-side mechanism for dynamically adapting the behavior of prompt generation and text output to the estimated emotional state of the user. Any personalization is usually limited to user interface preferences or client-side filtering, without influencing the way the server structures prompts, selects context, or chooses stylistic parameters for natural language generation. This leads to generic, non-adaptive commentary generation and does not fully exploit the capabilities of modern AI models to improve user-perceived responsiveness while still maintaining control and efficiency in server processing.

Fifth, current streaming architectures typically treat AI-generated text as an auxiliary, asynchronous data stream that is loosely associated with the video. The server often delivers such text via separate channels or APIs without strict synchronization with the timecodes of detected events. This separation complicates the client implementation, increases the risk of temporal mismatches, and makes it difficult to use the generated text directly in server-side or client-side control logic for display, navigation, or highlight playback. As a result, the overall system fails to provide a unified, time-synchronized data plane that combines video, audio, and AI-generated text in a technically coherent manner.

Therefore, there is a need for a computer-implemented system in which the server itself: (i) extracts and recognizes commentary audio to produce time-stamped textual data, (ii) detects excitement events through quantitative analysis of audio signals, (iii) fuses external structured match data with the time-stamped text to generate structured representations of events, (iv) automatically constructs prompt sentences for a generative AI model based on these representations, optionally adjusted by an estimated emotional state of the user, and (v) synchronizes and distributes the generated natural language documents together with the sports relay video as part of an integrated, low-latency streaming pipeline. Such a system would improve the technical operation of the server and the networked distribution environment by enabling event-aware, context-aware, and user-sensitive processing within the core media-delivery infrastructure, rather than relegating such functions to loosely-coupled, application-level components.

The specific processing by the specific processing unit 290 of the data processing device 12 in Example 1 is realized by the following means.

The present invention provides a server comprising a processor configured to receive a video input signal including a broadcast signal or a distribution signal, acquire sports relay video, separate an audio signal included in the sports relay video to generate audio data as an analysis target, execute speech recognition processing on the audio data to generate character information with time information, calculate a temporal change of an acoustic quantity based on the audio data, detect a change of the acoustic quantity that satisfies a predetermined condition to specify time information of an excitement event, acquire match information, group information, and participant information from an external information source, associate the acquired information with the time information of the excitement event and the character information to generate structured data, generate a prompt sentence including instructions relating to a match situation, an event content, and an output format on the basis of the structured data, input the prompt sentence to a generative AI model to cause the generative AI model to generate a natural language document, record the generated natural language document as related information in association with the time information of the excitement event and with a section of the sports relay video, estimate an emotional state of a user on the basis of operation information of the user or detection information relating to the user and, in accordance with the estimated emotional state, change an instruction content or a style condition included in the prompt sentence, synchronize the natural language document generated by the generative AI model with the time information of the excitement event, superimpose the natural language document on distribution data corresponding to the sports relay video, and continuously distribute the sports relay video together with the related information to a terminal device for use in display control or playback control. This enables the server to implement, within the core streaming and media-processing pipeline, an integrated and time-synchronized processing flow in which audio analysis, speech recognition, event detection, structured-data fusion, prompt generation, natural language generation, user-state-dependent adaptation, and synchronized distribution are executed as coordinated computer-implemented operations, thereby improving the efficiency, responsiveness, and technical reliability of live sports content delivery compared with conventional architectures that treat these functions as separate or loosely-coupled subsystems.

The term “video input signal” refers to an electrical or digital signal representing moving image content, including but not limited to broadcast signals and network-based distribution signals, that can be received and processed by a computing device.

The term “broadcast signal” refers to a media signal transmitted over a broadcast medium, such as terrestrial, satellite, or cable transmission, which is intended for reception by multiple receivers and which encodes at least video data and optionally audio and auxiliary data.

The term “distribution signal” refers to a media signal delivered over a packet-switched or circuit-switched communication network, such as the Internet or a managed IP network, and representing at least video data and optionally audio and auxiliary data for downstream consumption.

The term “sports relay video” refers to video data representing a live or recorded sporting event, including associated commentary and environmental sounds, suitable for real-time or time-shifted viewing by a user.

The term “audio signal” refers to a component of a media signal that represents sound, including commentary, environmental noise, and other audio elements, and that can be processed independently of associated video data.

The term “audio data” refers to digital data obtained from the audio signal, such as sampled waveform data or encoded audio frames, that is used as an input for analysis, recognition, or other computational processing.

The term “analysis target” refers to data, such as audio data or text data, that is designated to be subjected to one or more computational operations including recognition, detection, or evaluation.

The term “speech recognition processing” refers to a computational process that analyzes audio data representing human speech to produce textual data or symbolic representations corresponding to recognized words, phrases, or utterances.

The term “character information” refers to textual data, such as strings of characters or tokens, that represent the content of recognized speech or other linguistic information.

The term “time information” refers to data indicating temporal positions or intervals within a media stream, such as timestamps, timecodes, or presentation times, which allow synchronization between different data modalities.

The term “acoustic quantity” refers to a measurable parameter derived from audio data, such as amplitude, power, energy, loudness, spectral component, or other signal-derived metric indicative of audio characteristics.

The term “temporal change of an acoustic quantity” refers to a variation of an acoustic quantity over time, including increases, decreases, or fluctuations, calculated on the basis of audio data across successive time intervals.

The term “predetermined condition” refers to a condition defined in advance, such as a threshold, pattern, rule, or classification criterion, that is applied to a measured or computed value to determine whether a specific event is detected.

The term “excitement event” refers to a time-localized occurrence in a sports relay, such as a scoring event or a critical play, that is identified at least partly by a change in an acoustic quantity and optionally by associated textual or structured information.

The term “match information” refers to structured data describing a sporting contest, including at least identifiers of the contest, scores, periods, and time progression, and optionally additional contextual information.

The term “group information” refers to structured data describing organizations or teams participating in a sporting event, including identifiers, names, classifications, or other attributes of such organizations. The term “participant information” refers to structured data describing individual participants in a sporting event, such as players, officials, or coaches, including identifiers, roles, statistics, or other attributes.

The term “external information source” refers to a system or service, accessible over a communication network, that provides structured or unstructured data related to a sporting event, such as databases, application programming interfaces, or information feeds.

The term “structured data” refers to data that is organized according to a defined schema or format, such as tables, records, or key-value sets, enabling systematic association and processing of related information elements.

The term “prompt sentence” refers to a text string or set of instructions provided as input to a generative AI model, defining context, constraints, and desired characteristics of an output natural language document.

The term “match situation” refers to a state or context of a sporting event at a given time, including score, time remaining, team positions, and other relevant conditions derived from match information.

The term “event content” refers to descriptive information regarding what occurred during an identified event, including actions, outcomes, participants involved, and contextual details.

The term “output format” refers to a specification of structural or stylistic requirements for text to be generated by a generative AI model, such as length, tone, language, or layout constraints.

The term “generative AI model” refers to a machine-learned model configured to generate natural language text or other content in response to an input prompt sentence, based on parameters obtained from training on data sets.

The term “natural language document” refers to text data expressed in a human language and generated or processed by a computing device, including but not limited to summaries, descriptions, commentary, or explanations.

The term “related information” refers to data, including natural language documents and associated metadata, that is linked to specific time segments or events within a sports relay video.

The term “section of the sports relay video” refers to a temporal segment or interval of the sports relay video identified by time information and associated with one or more events or descriptions.

The term “terminal device” refers to an end-user device capable of receiving, decoding, and presenting media content and related information, such as a smartphone, tablet, personal computer, or television receiver.

The term “display control” refers to processing that governs the presentation of visual information on a display device, including timing, layout, overlay, and selection of content for display.

The term “playback control” refers to processing that governs the temporal reproduction of media content, including starting, stopping, seeking, or synchronizing playback of video, audio, or related information.

The term “operation information of the user” refers to data indicative of user interactions with a device or service, such as input events, selection logs, playback controls, or navigation patterns.

The term “detection information relating to the user” refers to data obtained by sensors or monitoring systems concerning a user, such as biometric signals, facial expressions, or gaze direction, that can be used to infer user state.

The term “emotional state of a user” refers to an estimated affective condition of a user, such as excitement, boredom, happiness, or disappointment, inferred from operation information or detection information relating to the user.

The term “instruction content” refers to specific directives or constraints included in a prompt sentence that guide the behavior of a generative AI model, such as what aspects to emphasize or omit.

The term “style condition” refers to parameters defining the manner in which a natural language document is to be generated, such as tone, politeness level, formality, or target audience characteristics.

The term “synchronize” refers to aligning multiple data streams or content items in time, such that they correspond to common time information or timecodes and can be presented coherently.

The term “superimpose” refers to combining or overlaying one data stream, such as text, onto another data stream, such as video, so that both can be presented together in a coordinated manner.

The term “distribution data” refers to media data prepared for transmission to one or more terminal devices, including encoded video, audio, and associated metadata or auxiliary content.

In one embodiment, a server cooperates with one or more terminals operated by a user to provide a real-time sports relay distribution system that generates and delivers time-synchronized, AI-generated natural language documents based on live audiovisual analysis and external structured data.

The server comprises at least one processor, a memory, a non-volatile storage device, a network interface, and a video acquisition interface. The server uses a digital tuner or equivalent video acquisition hardware to receive a broadcast signal, and uses a network interface to receive a distribution signal from a network-based media source. The server executes an operating system such as a general-purpose server operating system and runs software components including a media processing framework such as FFmpeg or an equivalent library, a speech recognition engine such as a neural network-based ASR engine, and a generative AI model execution environment such as a transformer-based language model runtime.

The terminal comprises a processor, a memory, a display device, an audio output device, and a network interface. The terminal executes an application that communicates with the server through a communication network to receive streaming media data and associated text data. The user operates the terminal to select desired sports content and to view and interact with distributed video and generated text.

The server receives a video input signal that encodes a sports relay video. The server uses media processing software, such as FFmpeg, to demultiplex the incoming media stream and separate a video component and an audio component. The server decodes the video component into a sequence of video frames stored in memory and decodes the audio component into a stream of audio samples represented as digital audio data (for example, 16-bit PCM samples). The server uses a hardware-accelerated decoding path, for example using a graphics processor's video decoding unit, to reduce CPU load and to increase throughput for high-resolution video streams.

The server executes speech recognition processing on the audio data. In one embodiment, the server uses a neural network-based ASR model that has an acoustic encoder and a language decoder. The acoustic encoder is implemented as a stack of convolutional layers followed by recurrent or transformer layers that accept a sequence of acoustic feature vectors, such as Mel-frequency cepstral coefficients or log Mel spectrogram frames. The language decoder is implemented as an attention-based recurrent network or a transformer decoder that receives the encoded acoustic sequence and outputs a sequence of token probabilities. The server performs a feature extraction algorithm in which the server converts raw audio samples into frames, applies a window function, performs a fast Fourier transform, and computes Mel-scaled filterbank energies to form feature vectors. The server normalizes these features and feeds them into the acoustic encoder.

The server executes a decoding algorithm, such as beam search, over the output token probabilities to generate character information representing recognized commentary phrases. During this decoding, the server associates each output token sequence with time information by aligning acoustic frames and token indices. The server stores, for each recognized phrase, a record containing a string of characters, a start time, an end time, and one or more confidence scores in a structured data store, such as a relational database. This time-aligned storage enables subsequent modules to retrieve textual descriptions corresponding precisely to specific time intervals in the sports relay video.

The server calculates a temporal change of an acoustic quantity based on the audio data. In one embodiment, the server computes a short-time energy or loudness metric over fixed-length audio windows (for example, 100 ms) and smooths the resulting time series using a digital filter. The server then compares the smoothed values to a baseline signal level maintained for the ongoing match. The server detects a sharp increase in acoustic quantity when the difference between the current value and a running median or exponential moving average exceeds a predetermined threshold, and when the duration of the elevated signal persists beyond a minimum interval. The server records the time information of such detected events and labels them as excitement events. The server optionally refines these detections by verifying that the corresponding recognized text contains keywords associated with highlight-worthy events, such as terms denoting scores or critical plays.

The server acquires match information, group information, and participant information from an external information source. The server uses a network interface to send requests, for example using HTTP, to a sports data service that returns structured data, such as JSON or XML, describing match identifiers, current scores, team identifiers, participant identifiers, positions, and statistics. The server parses this structured data and normalizes it into internal tables such as a match table, a group table, and a participant table stored in a relational database. The server periodically updates these tables to reflect the live state of the sporting event.

The server associates the acquired information with the time information of the excitement event and the character information to generate structured data representing event-level records. In one embodiment, the server constructs an event record that contains an event identifier, a timecode, associated teams and participants, recognized commentary text around that timecode, one or more acoustic metrics, and any available match state changes such as score updates. The server maintains these event records in a structured data store with appropriate indices on time and identifiers to support efficient retrieval.

The server generates a prompt sentence including instructions relating to a match situation, an event content, and an output format on the basis of the structured data. The server constructs a text string that encodes, in natural language, a concise description of the context of the event, the match situation, and explicit instructions to the generative AI model about the style and length of the output. The server retrieves the current score, team names, participant names and roles, and a snippet of the recognized commentary around the event time from the structured data store. The server concatenates these elements into a prompt sentence that may take a form such as:
“Using the following soccer commentary transcript and match data, write a 1-2 sentence highlight description that is suitable for a social media post. Focus on the goal at timecode 00:23:15. Transcript: ‘Team A is pushing forward on the right side . . . It's a goal! Team A scores!’ Teams: Team A vs Team B. Score after the goal: Team A 1-0 Team B. Player who scored: Player X (Team A).”

The server ensures that the prompt sentence contains explicit instructions on desired length, tone, and focus, so that the generative AI model can generate a natural language document that is aligned with technical constraints such as character limits or timing requirements.

The server executes a generative AI model to generate a natural language document based on the prompt sentence. In one embodiment, the server uses a transformer-based language model with multiple layers of self-attention and feedforward units, trained on textual corpora including sports descriptions and generic language. The server represents the prompt sentence as a sequence of input tokens and feeds these tokens into the encoder or decoder stack of the model, depending on the architecture. The server executes matrix multiplication operations to compute attention scores and hidden states layer by layer, using hardware acceleration where available, such as vector instruction sets or specialized accelerators.

The server calculates a loss function, such as cross-entropy between predicted token distributions and ground truth tokens, during a pre-training or fine-tuning phase, and updates model parameters using a gradient-based optimization algorithm such as stochastic gradient descent with momentum or Adam. The server can perform this training offline before deployment. At inference time, the server applies a decoding algorithm, such as greedy decoding or beam search with temperature control and top-k or nucleus sampling, to generate a sequence of output tokens that form the natural language document.

The server records the generated natural language document as related information in association with the time information of the excitement event and with a section of the sports relay video. The server stores, for each event record, the generated text, the timecode, and a reference to the corresponding video segment, which may be defined by a start time and an end time around the event time. The server may also generate a video clip that covers the time interval around the event by re-encoding or segmenting the original media, using the same media processing framework. The server stores a reference to the video clip alongside the generated text in a structured data store.

The server estimates an emotional state of the user on the basis of operation information of the user or detection information relating to the user. The terminal sends usage logs to the server, such as the frequency of highlight replays, the duration of attention to certain segments, or explicit feedback operations. The terminal optionally sends detection information from sensors, such as camera-based facial expression indicators or inertial sensor patterns, if permitted. The server inputs these features into a separate classifier model, such as a shallow neural network or gradient-boosted decision tree, that has been trained to infer an emotional label (for example, “highly engaged” or “disengaged”) or a scalar engagement score. The server normalizes input features across users and over time to reduce noise and then infers the emotional state.

The server changes an instruction content or a style condition included in the prompt sentence in accordance with the estimated emotional state. For example, when the server infers a highly engaged state, the server adds instructions in the prompt for more detailed tactical explanations, whereas for a low engagement state, the server adds instructions requesting shorter, more energetic summaries. By adjusting these instructions, the server influences specific generation parameters such as phrase length and emphasis without changing the underlying model architecture. This dynamic adaptation changes how the server structures prompts and thus modifies how the model behaves, enabling the system to perform context-aware and user-aware generation in a way that is technically integrated with the live processing pipeline.

The server synchronizes the natural language document generated by the generative AI model with the time information of the excitement event. The server ensures that the textual description is tagged with precise timecodes that correspond to presentation timestamps in the media stream. The server incorporates the generated text as timed metadata into the streaming output. In one embodiment, the server uses a streaming protocol such as a segmented HTTP-based streaming protocol and embeds the text as sidecar metadata files or as timed metadata packets that are associated with specific segments of the video. The server superimposes the natural language document on distribution data by combining the text with the video output, for example by rendering text overlays in the video at the server side or by transmitting the text with timecodes that allow the terminal to render the overlays in synchronization.

The server continuously distributes the sports relay video together with the related information to the terminal for use in display control or playback control. The server uses an HTTP-based streaming server to deliver segmented video files and associated metadata. The terminal requests media segments and metadata, decodes the video and audio using its own hardware decoders, and displays the streaming video on the display. The terminal parses the received text metadata and uses the timecodes to determine when to present highlights, subtitles, or overlay panels. The user can interact with the terminal to jump directly to specific events based on the generated text, and the terminal uses the timecodes to control playback position.

This configuration produces a technical improvement in the operation of the server and the overall streaming system. By integrating speech recognition, acoustic analysis, and generative text generation directly into the media-processing pipeline, the server reduces latency between an event occurring in the live video and the availability of an AI-generated description. The server reduces redundant data transfers by reusing decoded audio and video streams for both distribution and analysis, thus decreasing overall system load. The server improves accuracy of event localization by combining acoustic features with recognized text and external structured data, which reduces false detections compared to systems relying solely on one modality.

The server improves data management by maintaining structured event records that link audio, video, text, and external data through common timecodes and identifiers. This structured representation allows efficient query, retrieval, and reuse of data, supporting both real-time and post-event processing. The server improves computational efficiency by performing feature extraction and model inference in batch units aligned with streaming segments, leveraging vectorized operations and, where applicable, specialized accelerators.

The server reduces communication load between components by embedding text metadata into existing streaming channels instead of requiring separate, loosely synchronized communication paths.

By using a transformer-based generative AI model trained with explicit loss functions and parameter updates, the server implements a non-conventional processing approach that differs from manual human summarization or basic rule-based templates. The server applies model parameters and inference algorithms to generate context-aware text that is technically synchronized with the live stream. This is not a mere automation of human tasks; the server executes internal algorithms that operate at a granularity and speed that are not practically achievable by human operators, and the server exploits data structures and hardware-level operations to achieve this performance.

In further embodiments, the server uses alternative architectures for speech recognition, such as end-to-end encoder-decoder models trained with connectionist temporal classification, and alternative architectures for generative text, such as recurrent neural networks with attention. The server may also employ alternative external data sources or local databases for match information.

The terminal may implement different user interface layouts to present generated text, including on-screen overlays, scrolling commentary feeds, or interactive highlight timelines. The user can select different viewing modes on the terminal, such as a mode emphasizing critical highlights or a mode emphasizing tactical analysis, and the server can correspondingly adjust prompt sentences and generation styles.

In another embodiment, the server records and reuses event-level structured data and generated text for on-demand replay services. In such a scenario, the server creates a catalog of events and highlights for a completed match, and the terminal allows the user to select specific events to watch. The server supplies both the associated video clip and the previously generated descriptive text to the terminal. This reuse demonstrates that the data structures and processing implemented by the server are not confined to a single linear live transmission but can be exploited in multiple service modes.

Through these implementations, the server, the terminal, and the user cooperate to realize a system in which real-time sports relay video is analyzed, annotated, and distributed with time-synchronized, generative AI-based descriptions. The technical features of the server's processing pipeline, including specific data structures, algorithms, and model integrations, provide concrete improvements in processing speed, accuracy, data management, and communication efficiency over conventional systems that treat video distribution, commentary analysis, and text generation as independent or loosely coupled tasks.

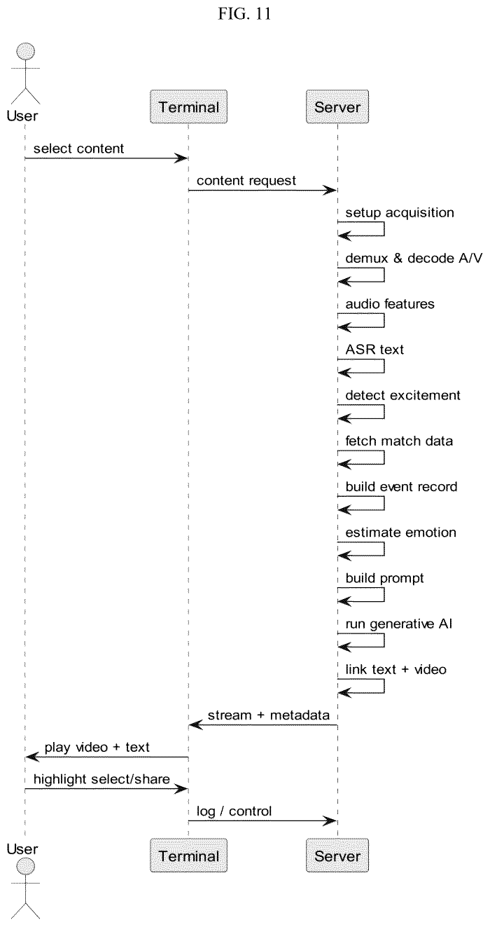

The following describes the processing flow using FIG. 11.

### Step 1:

User operates the terminal to select sports content to be viewed. User views a list of available sports programs, channels, or streaming sources displayed on the terminal, and selects one item using a touch operation, mouse click, or remote control.

Input: a set of selectable program identifiers or stream URLs presented on the terminal UI.

Processing: terminal receives the user's selection, packages it into a request message containing at least a content identifier (for example, channel ID, match ID, or stream URL) and user ID, and formats this message according to a communication protocol such as HTTP or WebSocket.

Output: a selection request transmitted from the terminal to the server, including metadata that uniquely specifies the desired sports relay video source.

### Step 2:

Server receives the selection request and configures media acquisition.

Server parses the request message to extract the content identifier and determines whether the source corresponds to a broadcast signal or a network distribution signal.

Input: request message containing content identifier and user information.

Processing: server accesses a configuration database to map the content identifier to physical acquisition parameters, such as tuner frequency, program map, or network URL. Server initializes a digital tuner for broadcast or a media client process for network streaming and allocates buffers in memory to store incoming packets.

Output: an active media acquisition session that continuously receives a video input signal corresponding to the selected sports relay.

### Step 3:

Server demultiplexes and decodes the incoming media stream.

Server uses a media processing library to separate the input container stream into video and audio elementary streams and to decode them into raw frame and sample data.

Input: compressed media packets forming the video input signal received from the acquisition hardware or network.

Processing: server invokes demultiplexing functions to identify stream types (video, audio, metadata) and decodes video frames using a video codec decoder and audio frames using an audio codec decoder. Server may use hardware acceleration to perform inverse transforms, motion compensation, and entropy decoding.

Output: a sequence of decoded video frames stored in frame buffers and a stream of decoded audio samples stored in audio buffers, each frame and buffer being associated with time information.

### Step 4:

Server performs audio feature extraction and prepares audio data for speech recognition.

Server processes the decoded audio samples to generate feature vectors that represent acoustic characteristics necessary for downstream analysis.

Input: decoded audio samples in digital form, ordered by time.

Processing: server segments audio into fixed-length frames, applies windowing functions, computes frequency-domain representations using fast Fourier transforms, and derives features such as Mel-frequency filterbank coefficients. Server normalizes these features over time to reduce variance.

Output: a time-ordered sequence of audio feature vectors, each tagged with time information, suitable for input to a speech recognition model and acoustic analysis routines.

### Step 5:

Server executes speech recognition to generate time-aligned text.

Server applies a neural network-based ASR model to the feature vectors to infer spoken words and phrases in the commentary.

Input: sequence of audio feature vectors with associated time indices.

Processing: server feeds feature vectors into an encoder-decoder model or comparable architecture, computes hidden states using matrix multiplications and non-linear activations, and performs decoding using beam search or similar algorithms to obtain the most probable character or word sequences. Server aligns output tokens with frame indices to assign start and end times.

Output: a set of text segments representing recognized commentary, where each segment includes character information, start time, end time, and confidence scores.

### Step 6:

Server computes acoustic quantities and detects excitement events.

Server analyzes the raw audio samples or derived features to quantify loudness or energy changes over time and identify significant peaks.

Input: decoded audio samples and corresponding time information, and optionally recognized text segments.

Processing: server computes short-time energy or loudness over sliding windows, smooths the resulting time series, and compares each value against a dynamic baseline using threshold functions. When a value exceeds the baseline by a set margin for a required duration, server marks this time region as a candidate excitement event. Server may confirm the candidate by checking if the recognized text in a nearby time window contains goal-related or highlight-related terms.

Output: a list of excitement events, each with an event timecode, an excitement score, and links to nearby text segments and audio segments.

### Step 7:

Server acquires and updates structured match data from external sources.

Server connects to external information services to obtain data about the current match, participating groups, and participants.

Input: match identifiers or league identifiers derived from the user's selection and system configuration.

Processing: server sends network requests to an external data service, receives structured responses describing scores, teams, players, and event logs, and parses these responses into internal data structures. Server stores the parsed data in a relational database and periodically refreshes the data as the match progresses.

Output: updated match information, group information, and participant information stored in structured form and linked to match identifiers.

### Step 8:

Server generates structured event records by fusing multimodal data.

Server combines audio-based event detections, recognized text, and external structured data into unified event-level records.

Input: list of excitement events with timecodes, recognized text segments with time ranges, and structured match data (scores, teams, participants).

Processing: server, for each excitement event, searches the text segments overlapping the event time and matches any score changes or logged events from the external data within a defined time window. Server constructs an event record that includes event type, involved teams and participants, pre-and post-event scores, audio metrics, and associated commentary text.

Output: a structured event dataset, where each record is a multidimensional representation of a detected event, indexed by time and identifiers.

### Step 9:

Server estimates the emotional state of the user.

Server analyzes user interaction logs and optionally sensor-derived indicators to infer the user's engagement or emotional response.

Input: user operation information such as play, pause, and seek actions, highlight replays, and any detection information such as facial expression metrics, if provided by the terminal.

Processing: server normalizes interaction metrics over a time window, extracts features such as replay frequency, dwell time on highlights, and pattern of skipping, and inputs these features to a trained classifier model that outputs an emotional label or numerical engagement score.

Output: an estimated emotional state or engagement profile associated with the user or session, updated over time.

### Step 10:

Server constructs a prompt sentence for the generative AI model.

Server uses the structured event records, match context, and estimated emotional state to build a detailed and context-aware instruction string.

Input: a selected event record, including match situation and commentary text, and user emotional state information.

Processing: server selects key fields such as teams, score, timecode, participant names, and commentary excerpt. Server chooses stylistic instructions based on emotional state (for example, technical tone for highly engaged users, concise tone for less engaged users). Server concatenates these elements into a coherent text instruction specifying what the generative AI model should generate, including length constraints and target style.

Output: a prompt sentence that fully specifies context, content focus, and output format for the generative AI model.

### Step 11:

Server executes the generative AI model to produce a natural language document.

Server applies a transformer-based language model or similar architecture to the prompt sentence to generate a descriptive text.

Input: prompt sentence containing match context, event content, and style instructions.

Processing: server tokenizes the prompt into subword units, feeds the token sequence into the model, and computes attention and feedforward layers to obtain probability distributions over output tokens. Server applies a decoding strategy such as beam search, top-k sampling, or nucleus sampling to select sequences that satisfy the requested style and length.

Output: a natural language document describing the excitement event, typically one or more sentences suitable for display or sharing, represented as a text string.

### Step 12:

Server associates the generated document with media segments and stores related information.

Server binds the natural language document to the corresponding video section and stores all information in a retrievable form.

Input: generated natural language document, event record with timecode and score change, and identifiers for video frames or segments.

Processing: server defines a video interval around the event time, for example from several seconds before to several seconds after the event, and records this interval as a clip reference. Server creates a record that includes the document text, the time interval, a reference to the video clip, and any additional metadata such as excitement score. Server inserts this record into a database optimized for retrieval by time or event type.

Output: a set of stored related information records linking video segments, timecodes, and AI-generated text.

### Step 13:

Server packages synchronized video and related information for distribution.

Server prepares streaming output that includes both media segments and synchronized text data.

Input: live video frames and audio samples, timecodes, and related information records for current and recent events.

Processing: server encodes video and audio into a streaming-friendly format, segments the stream into small files, and either embeds timed text metadata into the media or generates separate metadata files that are indexed by time. Server ensures that the timestamps of the natural language documents align with the presentation timestamps of corresponding media segments.

Output: a set of streaming media segments and associated metadata objects available via a streaming server for consumption by terminals.

### Step 14:

Terminal receives streaming data and renders synchronized content.

Terminal retrieves media segments and metadata from the server and presents video and text to the user.

Input: video and audio segments, and metadata containing time-aligned natural language documents and event markers.

Processing: terminal decodes the media using its hardware or software decoders, plays back the video and audio on the display and speakers, parses metadata to determine when to show specific text, and renders overlays or panels at appropriate times. Terminal may also create interactive UI elements, such as a highlight list derived from related information records.

Output: a real-time presentation of sports relay video with synchronized AI-generated descriptions, visible and audible to the user, along with interactive controls based on event markers.

### Step 15:

User interacts with highlights and generated descriptions.

User uses the terminal interface to navigate, view, and optionally share the generated content.

Input: UI elements such as highlight lists, text overlays, and control buttons presented by the terminal.

Processing: user selects highlight entries, taps on descriptions, or uses seek operations to jump to events. The terminal sends corresponding commands to the playback engine to adjust playback position or to fetch specific clips. User may activate a share function, causing the terminal to package the natural language document and a link to the video segment for external communication.

Output: updated playback state on the terminal, optional outbound share messages, and additional interaction logs that the server can use for future emotional state estimation and system adaptation.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented systems for processing sports broadcast content mainly rely on manually curated highlight markers, static rules, or pre-authored templates to generate summaries and highlight clips. Such systems typically ingest a pre-produced feed that already contains editorial decisions, and simply repackage or redistribute this content. As a result, these systems have limited ability to adapt in real time to dynamic broadcast conditions, to automatically discover previously unmarked important moments, or to generate context-sensitive explanatory text tailored to different users. From a computing standpoint, existing solutions do not sufficiently integrate low-level multimedia signal processing, structured event modeling, and generative artificial intelligence in a coordinated processing pipeline. In particular, conventional systems often: (i) treat audio analysis, speech recognition, and video analysis as separate silos without unifying their outputs into a consistent event representation; (ii) lack mechanisms to convert such structured event data into machine-readable conditioning data for a generative AI model via dynamically constructed prompt sentences; and (iii) provide only static, one-size-fits-all textual output that is not personalized based on user-specific attributes or interaction context. This results in underutilization of available computational resources and leads to inefficiencies, such as redundant processing, poor reuse of intermediate analysis results, and increased latency in generating meaningful, machine-generated highlight content. Furthermore, when attempting to use generative AI models in this domain, known approaches frequently send raw or minimally processed text transcripts to the model, forcing the model itself to infer temporal structure, event types, and relationships between entities. This imposes a heavy reasoning burden on the generative AI model, increases computational cost, and can lead to inconsistent or inaccurate outputs. Additionally, there is little support for iterative refinement of prompts based on user behavior, thereby limiting the system's ability to generate personalized explanations or summaries while maintaining predictable resource consumption and response times.

Accordingly, there is a need for a computer-implemented system and processing architecture that: (i) automatically and robustly extracts, normalizes, and fuses multimodal information (audio, video, and external match data) into structured event data; (ii) systematically generates prompt sentences and conditioning information for a generative AI model from that structured data, in real time; and (iii) dynamically adapts the generation and presentation of highlight videos, descriptive sentences, and statistical information based on user-specific attributes and interactions. Such a system should improve the overall efficiency and technical performance of the computing environment—by reusing shared intermediate representations, reducing redundant computation, and organizing data in a form that allows the generative AI model to operate more effectively and with lower latency—thereby achieving an improvement in computer technology itself rather than merely automating a mental process.

The specific processing by the specific processing unit 290 of the data processing device 12 in Application Example 1 is realized by the following means.

The present invention provides a server comprising a processor configured to acquire a broadcast video signal of a sports event, separate an audio signal from the broadcast video signal, and convert the separated audio signal into data in a format suitable for acoustic analysis processing and speech recognition processing; to calculate volume information in a time domain or a frequency domain for the audio signal, detect a sudden change in the volume based on a predetermined criterion, and identify time information corresponding to an exciting portion of a match based on a result of the detection; to apply a speech recognition process to the audio signal to generate character information, and extract predetermined words or expressions from the character information to evaluate an importance level of the exciting portion; to identify a scoreboard region or a display region from the broadcast video signal by image processing and character recognition processing, acquire score information, group information, competitor information, and time information of the match from the region, and/or acquire match information from an external information source; to integrate the exciting portion based on the volume change, the character information, the match information, and the time information to generate and store structured data for each event, the structured data including at least an event type, a related group, a related competitor, a score change, and the importance level; to select, based on the structured data, an important moment of the match, statistical information, and a video section corresponding to the important moment, and dynamically generate a prompt sentence to be input to a generative AI model; to input the prompt sentence and the structured data to the generative AI model, cause the generative AI model to generate at least one of a highlight description sentence, a match summary sentence, and an explanatory sentence, and associate and store a generated sentence with the structured data and the video section; and to determine a clipping range for the video section by referring to the structured data, generate a highlight video, and associate the highlight video with the generated sentence and the statistical information to generate distribution data or output data. This enables the computing system to automatically construct and maintain a unified event-centric data structure from heterogeneous multimedia inputs, to generate optimized prompt sentences that condition a generative AI model with precisely the structured context needed for efficient text generation, and to produce, with reduced latency and improved computational efficiency, machine-generated highlight videos and personalized textual explanations that are dynamically tailored to user attributes and interactions, thereby providing a concrete improvement in the functioning of the underlying computer system and its resource utilization.

The term “broadcast video signal” refers to a sequence of image data and associated timing information representing a sports event that is transmitted or streamed from a content source, such as a television broadcast system or a network distribution system, in a form suitable for reception and decoding by electronic equipment.

The term “sports event” refers to an organized competitive activity involving one or more groups or competitors, conducted according to predefined rules, and capable of being visually and/or audibly recorded and transmitted as a broadcast.

The term “audio signal” refers to an electrical or digital representation of sound associated with the broadcast video signal, including at least one of commentator speech, crowd noise, ambient sound, and other audio elements.

The term “acoustic analysis processing” refers to a computational procedure that operates on the audio signal to derive quantitative or qualitative characteristics, such as volume level, frequency distribution, or temporal patterns, which can be used to infer properties of the underlying sound.

The term “speech recognition processing” refers to a computational procedure that converts an audio signal containing human speech into corresponding character information, such as text data representing words, phrases, or sentences.

The term “volume information” refers to numerical data representing a magnitude of the audio signal, such as an amplitude, energy, or power level, computed in a time domain or a frequency domain over a given interval.

The term “sudden change in the volume” refers to a change in the volume information that exceeds a predetermined threshold or meets a predetermined condition within a specified time window, indicating an abrupt increase or decrease in sound intensity.

The term “time information” refers to data indicating a temporal position or interval associated with the broadcast video signal or the audio signal, such as an absolute time stamp, a relative time offset, or a match clock value.

The term “exciting portion of a match” refers to a time period within a sports event during which a notable or significant occurrence, such as a scoring event or a critical play, is inferred based on at least one of audio characteristics, speech content, or match information.

The term “character information” refers to symbolic data, such as textual data composed of characters, words, or sentences, generated by applying speech recognition processing to the audio signal.

The term “predetermined words or expressions” refers to specific lexical items, phrases, or patterns in the character information that are designated in advance as indicative of an important or noteworthy occurrence in the sports event.

The term “importance level” refers to a parameter or score that represents a degree of significance assigned to an event or an exciting portion of a match, derived from one or more factors such as volume change, speech content, or match context.

The term “scoreboard region” refers to an area within an image frame of the broadcast video signal that visually presents match-related textual or graphical information, such as scores, team names, or time.

The term “display region” refers to an area within an image frame of the broadcast video signal in which supplemental information related to the sports event, such as competitor names, statistics, or event labels, is rendered.

The term “image processing” refers to a computational procedure that analyzes or transforms digital image data to detect, segment, classify, or otherwise interpret visual features within the broadcast video signal.

The term “character recognition processing” refers to a computational procedure, including optical character recognition, for detecting and converting visual representations of characters or symbols in image data into corresponding character information.

The term “score information” refers to data indicating at least one of a current score, a score change, or a scoring history of the sports event for one or more groups.

The term “group information” refers to data identifying or describing an organized entity participating in the sports event, such as a team, club, or representative unit.

The term “competitor information” refers to data identifying or describing an individual or sub-entity that participates in the sports event, such as a player, athlete, or participant role.

The term “match information” refers to data describing a state or context of the sports event, including at least one of score information, group information, competitor information, time information, period information, or event type information.

The term “external information source” refers to a system or service that is distinct from the processing server and that provides match information, such as a data feed, database, or network service accessible via a communication interface.

The term “structured data” refers to data organized according to a defined schema or data model, in which fields such as event type, related group, related competitor, score change, time information, and importance level are explicitly represented and machine-readable.

The term “event” refers to a unit of occurrence within the sports event, associated with specific time information and characterized by at least an event type, one or more related groups or competitors, and optionally a score change or contextual attributes.

The term “event type” refers to a classification label assigned to an event, indicating a category of occurrence such as scoring, attempt, foul, substitution, or other predefined class.

The term “related group” refers to a group that is associated with an event, such as a team that scored, defended, committed an infringement, or otherwise participated in the event.

The term “related competitor” refers to an individual or sub-entity that is associated with an event, such as a player who scored, attempted a play, committed an action, or otherwise participated in the event.

The term “score change” refers to information indicating a transition of score information resulting from an event, including at least one of a new score value and a difference relative to a previous score.

The term “statistical information” refers to aggregated or derived numerical data representing performance or state of groups or competitors, such as counts, rates, distances, percentages, or other quantitative metrics.

The term “video section” refers to a temporal segment of the broadcast video signal that corresponds to a specified time interval, including at least part of an exciting portion or event.

The term “clipping range” refers to start and end time positions within the broadcast video signal that define boundaries of a video section to be extracted.

The term “highlight video” refers to a video sequence generated by extracting one or more video sections corresponding to important moments or events of the sports event, optionally with associated metadata.

The term “distribution data” refers to data prepared for transmission or delivery to a terminal or external device, including at least one of highlight video data, generated sentences, and statistical information.

The term “output data” refers to data formatted for presentation or storage by a device, including at least one of visual, audio, or textual data derived from the highlight video, generated sentences, or statistical information.

The term “generative AI model” refers to a computational model based on machine learning that is configured to generate output data, such as natural language text, in response to input data and control instructions.

The term “prompt sentence” refers to control text or instruction text formulated to be provided as input to the generative AI model, the prompt sentence specifying at least one of a generation task, desired style, content constraints, or use of structured data.

The term “highlight description sentence” refers to a natural language text segment generated by the generative AI model that describes an important moment or event of the sports event.

The term “match summary sentence” refers to a natural language text segment generated by the generative AI model that summarizes a portion or entirety of the sports event.

The term “explanatory sentence” refers to a natural language text segment generated by the generative AI model that provides additional explanation, context, or analysis regarding an event, a group, a competitor, or the match flow.

The term “display device” refers to an electronic device configured to present visual information to a user, including at least one of a terminal, a monitor, a mobile device, or a head-mounted display.

The term “user attribute” refers to information indicating a characteristic, preference, or state associated with a user, including at least one of a preferred detail level of explanation, a preferred writing style, a favored group, a favored competitor, or a language preference.

The term “state information of the user” refers to data representing a condition, interaction history, or context of a user, such as recent selection operations, viewing behavior, engagement indicators, or explicitly provided settings.

The term “personalized highlight description sentence” refers to a highlight description sentence whose content, style, or detail level has been generated or adjusted based on at least one user attribute or state information of the user.

The term “personalized match summary sentence” refers to a match summary sentence whose content, focus, or expression has been generated or adjusted based on at least one user attribute or state information of the user.

In one embodiment, the system includes a server, one or more terminals, and one or more users. The server is implemented as an information processing apparatus comprising at least one multi-core central processing unit, a graphics processing unit, a main memory, a non-volatile storage device, and a network interface. The terminal is implemented as a mobile computing device, a tablet device, a stationary client device, or a display device having a processor, a memory, a display, and a network interface. The user operates the terminal.

The server executes an operating system and multiple software modules, including a multimedia processing module, an audio analysis module, a speech recognition client module, an image analysis module, a structured event generation module, a statistics calculation module, a prompt generation module, a generative AI client module, a highlight generation module, a storage control module, and a communication module. The server is connected, via the network interface, to an external generative AI model service, an external speech recognition service, and one or more external match information services.

The server uses a multimedia processing library such as a generic video processing library (for example, a library implementing functionality similar to OpenCV) and a generic media framework (for example, a framework implementing functionality similar to FFmpeg) to acquire and decode a broadcast video signal. The broadcast video signal is input from a tuner device, a streaming receiver, or a packet-based network stream. The server configures a hardware encoder/decoder available on the graphics processing unit to perform video decoding operations, thereby offloading intensive pixel-level processing from the central processing unit and reducing decoding latency. The server stores decoded video frames and a separated audio signal in a ring buffer structure in the main memory. By using a ring buffer with timestamp indices, the server reduces random memory access and improves data locality, which contributes to faster subsequent analysis.

The server uses the audio analysis module to perform acoustic analysis processing on the separated audio signal. The audio analysis module operates on fixed-size frames (for example, 20 to 50 milliseconds) of pulse-code-modulated samples. The server uses numerical libraries (for example, libraries implementing fast Fourier transform and vectorized operations similar to NumPy and SciPy) to calculate short-time energy values and, optionally, frequency-domain power spectra for each frame. The server maintains a moving average and variance of the volume information and compares the current frame values against a dynamic threshold. The threshold is computed as a function of the moving average and standard deviation, for example as a base value plus a multiple of the standard deviation. When the server detects that the volume information exceeds the threshold for at least a minimum number of consecutive frames, the server marks the corresponding time region as a candidate exciting portion. This adaptive thresholding and sliding-window analysis improve detection robustness over static thresholding, thereby reducing false positives and false negatives and improving the accuracy of excitement detection.

The server uses the speech recognition client module to submit segments of the audio signal to an external speech recognition service. The server configures a segmentation strategy where overlapping windows (for example, 15 seconds with an overlap of 3 seconds) are extracted from the audio buffer and sent over a secure network connection using compressed audio formats to reduce bandwidth consumption. The external speech recognition service may employ an acoustic model and a language model implemented as a neural network. The server receives character information (text) with token-level or phrase-level time alignments.

The server merges overlapping segments by resolving conflicts based on confidence scores provided by the recognition service and stores the resulting text in a text store, indexed by time information.

The server uses the image analysis module to perform image processing and character recognition processing on selected video frames. The server periodically subsamples frames according to a sampling interval that depends on expected scoreboard update frequency. The server applies image processing techniques such as template matching, edge detection, and region-of-interest extraction to locate a scoreboard region or other display region where textual overlays appear. The server uses a character recognition engine (for example, an engine implementing optical character recognition functionality similar to Tesseract) to convert visual text content into character information. This character information is then parsed to obtain score information, group information, competitor information, and time information. By performing local region-of-interest detection before optical character recognition, the server reduces the number of pixels processed by the recognition engine and therefore improves processing speed and reduces energy consumption.

The server uses the structured event generation module to integrate the outputs of the audio analysis module, the speech recognition client module, the image analysis module, and any external match information services. The server defines a structured data format for events using a schema that includes at least fields for event identifier, event type, related group, related competitor, score change, importance level, and associated time information. The server maps each candidate exciting portion detected by the audio analysis module to a corresponding time interval and cross-references that interval with the character information obtained from speech recognition. The server extracts predetermined words or expressions, such as “goal,” “scores,” and “penalty,” and assigns preliminary event types based on a rule set. The server then uses the parsed scoreboard data and external match information to confirm or adjust event types and score changes and to link related groups and competitors.

The server may implement an event importance scoring algorithm that combines multiple features, including volume change magnitude, duration of elevated volume, presence of predetermined words or expressions, score change magnitude, and match context (for example, whether the event occurs near the end of the match). In one implementation, the server constructs a feature vector for each candidate event and applies a trained classifier model, such as a feedforward neural network having an input layer corresponding to the feature vector, one or more hidden layers with rectified linear unit activation functions, and an output layer producing an importance score. This neural network is trained offline using labeled historical match data, a loss function such as mean squared error or cross-entropy (depending on regression or classification formulation), and a gradient-based optimization method such as stochastic gradient descent with momentum or an adaptive learning rate optimizer. Training may apply data augmentation in the feature space, including additive noise to volume features and slight shifts to time features, to improve robustness. At runtime, the server only performs forward inference, which is computationally efficient and suitable for real-time processing.

The server uses the statistics calculation module to aggregate events and generate statistical information for groups and competitors. The server maintains in-memory counters and running aggregates (for example, cumulative sums, averages, moving windows) in a key-value structure indexed by identifiers of groups and competitors. By updating these aggregates incrementally as each event is processed, the server avoids repeatedly scanning the entire event history, thereby reducing computational complexity from linear in the number of events to constant or logarithmic for many queries. This incremental aggregation improves processing speed and enables low-latency updates to statistics.

The server uses the prompt generation module to construct a prompt sentence for a generative AI model. The prompt generation module is configured to transform structured data into a compact, semantically rich text representation. The server may, for example, convert event records into a list of short lines that specify time, group, competitor, event type, and score change, and then embed that list into a natural language instruction. The server may generate different prompt templates depending on whether the generative AI model should produce highlight description sentences, match summary sentences, or explanatory sentences. For example, the server may generate a prompt sentence such as:
“The following data describes important events in a soccer match. For each event, generate a short highlight description in natural language, including the time, the teams involved, the key competitor, and the score change. Use fewer than 30 words per highlight. Events: [time=67:32, event=goal, team=A, player=9, score change=1].”

In another example, the server may generate a prompt sentence such as:
“Generate a neutral match summary of approximately 600 words based on the following key events and statistics of the game. Emphasize turning points and performance of the main competitors. Data: [events and statistics list].”

By using structured data and predetermined templates, the server restricts the input space for the generative AI model and reduces ambiguity in the model's task, which leads to more consistent outputs and shorter generation time.

The server uses the generative AI client module to send the prompt sentence and associated structured data to an external generative AI model service. The generative AI model may be implemented as a neural network comprising a transformer architecture with multiple self-attention layers, feedforward sublayers, and positional encoding. The model is pre-trained on large corpora of text and optionally fine-tuned on task-specific data such as sports commentary and match reports. During training, the model uses a token-level loss function such as cross-entropy between predicted tokens and reference tokens and updates its weights via backpropagation and a gradient-based optimizer. Regularization techniques such as dropout and layer normalization may be used to stabilize training. The generative AI model may also be configured with a maximum sequence length and a top-k or nucleus sampling strategy to control output diversity at inference time.

At runtime, the server does not perform training but performs inference by encoding the prompt sentence and any structured data into tokens, passing them through the transformer network, and decoding the resulting token probabilities into output text. The server configures decoding parameters such as maximum number of tokens, temperature, and sampling strategy to balance variety and determinism. By pre-processing the data into structured form and constraining prompts, the server reduces the amount of reasoning the generative AI model must perform, which decreases computational load on the external model service and shortens response time. This constitutes an improvement in computing efficiency relative to an approach that would submit unstructured raw transcripts to the model.

The server uses the highlight generation module to map generated sentences to corresponding video sections. The server uses the time information and the structured event data to determine a clipping range, such as N seconds before and M seconds after the event time. The server instructs the multimedia processing module to extract the corresponding segment from the decoded video frames and to encode it as a highlight video. The server may use a hardware encoder available on the graphics processing unit to transcode the video segment into a compressed format suitable for streaming. The server associates the highlight video with the generated highlight description sentence, and, when available, with associated statistical information. The server then stores this association in a storage system and registers distribution data, such as a uniform resource locator or an identifier for each highlight package.

The terminal uses a communication module to request highlight packages, statistical information, and generated sentences from the server. The terminal receives distribution data via a network and stores the received data in a local cache. The terminal uses a rendering module and a user interface framework to display a list of highlight items in chronological order or sorted by importance level. Each list item includes at least a time label, a short description sentence generated by the generative AI model, and optionally a minimal set of statistical values. When the user selects an item through a touch operation, a click operation, or other input, the terminal retrieves or streams the associated highlight video and displays it on the screen while superimposing the generated sentence and at least a portion of the statistical information.

The terminal may also include a local prompt generation module and a local generative AI client module for personalization. The terminal maintains user attributes such as preferred group, preferred competitor, preferred language, desired level of detail, and style preferences. The terminal may determine these attributes from explicit settings and from state information of the user, such as interaction logs indicating which highlights the user often views. The terminal uses these attributes to modify or refine a prompt sentence sent to the generative AI model. For example, the terminal may generate a prompt sentence such as:
“Rewrite the following highlight descriptions from the perspective of a supporter of Team A. Use an enthusiastic but easy-to-understand tone and keep each description under 20 words. Original descriptions: [list of sentences].”

In another example, when the user taps a specific event and selects “Explain this play,” the terminal generates a prompt sentence such as:
“Explain why the goal at match time 67:32 was important, using the following context: current score, recent attempts, and remaining time. Write for a beginner viewer and limit the explanation to about 120 words. Context: [context text].”

The terminal sends the prompt sentence and associated input text to the generative AI model and displays the returned personalized description or explanation. By generating prompt sentences that explicitly encode user attributes, the terminal allows the generative AI model to output text tailored to individual users without duplicating highlight generation logic on the server, thereby distributing computation efficiently between server and terminal. The user interacts with the terminal by selecting highlights, requesting explanations, and changing settings. The user does not need to manage or analyze raw data; instead, the user is presented with machine-generated highlight videos and text in real time. The user can follow the progress of the match, understand key events, and review post-match summaries generated from the structured event data.

From a technical perspective, the described architecture improves computer technology along multiple dimensions. The server unifies heterogeneous multimedia data (audio, video, external match data) into a single structured event representation that is reused by multiple downstream modules. This reduces redundant computation that would occur if each module individually re-analyzed raw data. The server applies adaptive volume-based detection and machine-learned importance scoring to pre-filter events before invoking the generative AI model. This pre-filtering reduces the number of prompts and the volume of data submitted to the external model, thereby reducing communication load and inference time.

The structured event representation also allows the server to organize its storage and indexing around event identifiers and time information, enabling efficient queries for video segments and statistics. This improves database performance and reduces latency when constructing highlight packages or fulfilling terminal requests. Because the generative AI model receives structured data embedded in well-defined prompt sentences, the model can generate consistent outputs with fewer tokens, which reduces computational cost and network usage. Furthermore, the described use of generative AI is not a mere automation of human editorial work. The server implements non-conventional processing steps that integrate signal-level audio analysis, optical character recognition, and structured event modeling, and uses these to construct machine-oriented prompt sentences. The generative AI model operates on this structured input according to learned parameters that were optimized through machine learning procedures, which differ fundamentally from human reasoning processes. The system's specific combination of data structures, algorithms, and neural network inference yields measurable improvements in processing speed, highlight detection accuracy, and resource utilization compared to conventional systems that lack integrated event modeling or that pass only unstructured text to generative models.

Alternative embodiments are possible. The server may employ different neural network architectures for importance scoring, such as convolutional networks over spectrograms or recurrent networks over event sequences. The generative AI model may be hosted on the server instead of an external service, and the server may configure memory layout and batching strategies to process multiple prompts in parallel, increasing throughput. The image analysis module may employ feature-based template matching, deep learning-based detection, or hybrid methods to locate scoreboard regions. The system may support different sports by adjusting the predetermined words or expressions and the event type schema, while reusing the same core processing pipeline. The terminal may include an on-device language model for personalization, reducing dependency on network connectivity and further improving latency. In all such variations, the central concepts of structured event generation, prompt sentence construction from that structured data, and coordinated use of a generative AI model to produce highlight description sentences, match summary sentences, and explanatory sentences remain consistent.

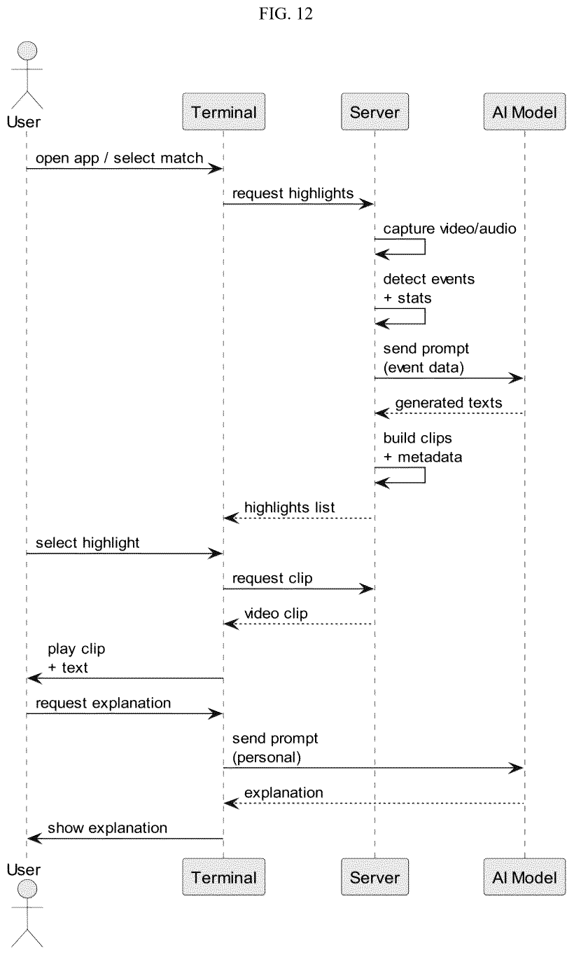

The following describes the processing flow using FIG. 12.

### Step 1:

The server acquires a broadcast video signal of a sports event. The input is a transport stream or containerized media stream received from a tuner, a network stream, or a storage system.

The server uses a multimedia framework to demultiplex the stream into a video stream and an audio stream and decodes the video frames using a hardware or software decoder. The server assigns timestamps to each decoded frame and audio buffer and stores them in a ring buffer in main memory. The output is a time-aligned sequence of raw video frames and an audio signal, both indexed by precise time information.

### Step 2:

The server normalizes and segments the audio signal. The input is the continuous audio stream from Step 1. The server converts the audio to a uniform format, such as mono pulse-code-modulated samples at a fixed sampling rate. The server partitions the audio into overlapping analysis frames and larger segments suitable for speech recognition. The server records the start and end time information for each frame and segment. The output is a set of audio frames for volume analysis and audio segments for speech recognition, each associated with time information.

### Step 3:

The server performs acoustic analysis to detect changes in volume. The input is the set of audio frames from Step 2. The server calculates, for each frame, a feature such as root mean square energy or log-scaled amplitude by summing squared sample values and taking a square root or logarithm. The server maintains a moving average and variance of these features over a sliding window and computes a dynamic threshold. When the feature values exceed the threshold for a minimum number of consecutive frames, the server marks the corresponding time interval as a candidate exciting portion. The output is a list of candidate exciting portions, each with start and end time information and volume-related features.

### Step 4:

The server performs speech recognition on the audio segments. The input is the set of audio segments from Step 2. The server sends compressed versions of the segments to an external or internal speech recognition engine via a network interface. The speech recognition engine converts the audio to character information, providing recognized words and phrases with time alignments and confidence scores. The server merges overlapping segment results by resolving conflicts based on time and confidence values. The output is a time-aligned transcription of commentator and crowd-related speech, stored as character information associated with time information.

### Step 5:

The server extracts predetermined words or expressions from the transcription and correlates them with exciting portions. The input is the character information from Step 4 and the candidate exciting portions from Step 3. The server scans the transcription within time windows around each candidate exciting portion to search for predetermined words or expressions that indicate important events, such as scoring events or penalties. The server counts occurrences, records positions, and assigns preliminary labels such as “goal” or “foul” to each candidate exciting portion. The output is an enriched list of candidate exciting portions, each annotated with detected keywords, preliminary event types, and an intermediate importance score.

### Step 6:

The server analyzes video frames to detect scoreboard and overlay regions. The input is the time-aligned video frames from Step 1. The server periodically samples frames based on a configurable interval and uses image processing operations such as template matching, edge detection, and color thresholding to identify a scoreboard region or other display regions. The server may maintain templates of known scoreboard layouts and compare them with frame subregions using similarity metrics. The output is a set of detected regions of interest in the video frames, each associated with time information.

### Step 7:

The server performs character recognition on the detected regions to obtain match information. The input is the detected regions of interest from Step 6. The server calls a character recognition engine to convert visual text in each region into character information. The server parses the recognized text to extract score information, group information, competitor information, and time information, using pattern matching and formatting rules. The output is a structured set of match information records, each containing at least a score value, group identifier, time value, and any visible competitor names or numbers, all associated with the corresponding video frame time.

### Step 8:

The server integrates audio-based events, transcription, and match information into structured event data. The input is the annotated candidate exciting portions from Step 5 and the match information records from Step 7. The server aligns time information from audio-based events with time information from the scoreboard and external match data. For each candidate exciting portion, the server identifies the nearest scoreboard record before and after the event and determines whether a score change occurred. The server assigns event identifiers, confirms or updates event types, and links each event to specific groups and competitors. The server also computes a final importance level by combining volume features, keyword detection, score change magnitude, and match context using a scoring function or a trained classifier. The output is structured event data, in which each record includes an event type, related group, related competitor, score change, time information, and importance level.

### Step 9:

The server calculates statistical information for groups and competitors. The input is the structured event data from Step 8. The server initializes or updates counters and aggregates stored in memory structures such as hash maps indexed by group and competitor identifiers. For each event, the server increments counts (for example, shots, goals, fouls), updates running totals (for example, distance run if available), and recalculates derived metrics such as shooting accuracy or possession estimates. The server maintains both cumulative and interval-based statistics by storing time-stamped aggregates. The output is statistical information representing the evolving performance of groups and competitors throughout the event.

### Step 10:

The server selects important events and corresponding video sections for highlight generation. The input is the structured event data from Step 8 and the importance levels associated with each event. The server sorts or filters events based on importance thresholds, event types, or a predefined maximum number of highlights. For each selected event, the server calculates a video section by subtracting and adding predefined margins from the event time to determine a clipping range. The server verifies that the clipping range lies within the bounds of the available video frames and adjusts the start and end times if necessary. The output is a selection of important events and their associated clipping ranges, prepared for highlight video extraction.

### Step 11:

The server generates a prompt sentence for a generative AI model based on the structured event data and statistics. The input is the selected events from Step 10 and the statistical information from Step 9. The server constructs a text representation of the events, for example as lines including time, group, competitor, event type, and score change. The server inserts this representation into a prompt template that specifies the task to the generative AI model. For highlight descriptions, the server may generate a prompt sentence such as: “The following data describes important events in a soccer match. For each event, generate a short highlight description in natural language, including the time, the teams involved, the key competitor, and the score change. Use fewer than 30 words per highlight. Events: [event list].” The output is at least one prompt sentence and the associated formatted event and statistics text.

### Step 12:

The server submits the prompt sentence and associated data to the generative AI model and obtains generated text. The input is the prompt sentence and formatted event and statistics text from Step 11. The server sends this input via the generative AI client module to a generative AI model implemented as a neural network. The generative AI model processes the tokens representing the prompt and outputs tokens representing natural language text, such as highlight description sentences, match summary sentences, or explanatory sentences.

The server receives the generated text, checks for errors or truncation, and, if necessary, applies post-processing to correct formatting or remove extraneous content. The output is a set of generated sentences associated with specific events and overall match context.

### Step 13:

The server associates generated sentences with video sections and statistical information and prepares highlight packages. The input is the selected events and clipping ranges from Step 10 and the generated sentences from Step 12, as well as the statistical information from Step 9. The server performs a join operation between these data structures using event identifiers and time information. The server constructs highlight package records that include a reference to the video section, the appropriate generated sentence, and key statistics such as score at that moment or performance indicators for relevant competitors. The output is a list of highlight package definitions, ready for video extraction and distribution.

### Step 14:

The server extracts and encodes highlight videos according to the clipping ranges. The input is the highlight package definitions from Step 13 and the time-aligned video frames from Step 1. The server instructs the multimedia processing module to cut segments from the original video based on the clipping ranges for each event. The server uses an encoder to compress the video segments into a distribution format such as a streaming-friendly container. The server stores the resulting files or stream identifiers in storage and updates the highlight package records with uniform resource locators or other access keys. The output is a set of encoded highlight videos associated with generated sentences and statistical information.

### Step 15:

The server transmits highlight package metadata and access information to the terminal. The input is the complete set of highlight package records from Step 14. The server exposes an application programming interface that returns, for each highlight, identifiers, timestamps, importance levels, short generated descriptions, basic statistics, and video access information. The server may push updates to the terminal when new highlights are created or respond to polling requests from the terminal. The output is structured metadata delivered over a network to one or more terminals.

### Step 16:

The terminal receives highlight metadata and displays a highlight list to the user. The input is the highlight package metadata from Step 15. The terminal parses the metadata and stores it in a local cache. The terminal uses a user interface framework to render a list of highlights ordered by time or importance. Each list item shows a time label, at least part of the generated highlight description sentence, and optionally a score snapshot or an icon indicating the event type. The output is a visual highlight list displayed on the terminal's screen, available for user interaction.

### Step 17:

The user selects a highlight item or requests additional explanation. The input is the displayed highlight list and user input via touch, click, or remote control. The user taps or clicks a highlight entry to view the corresponding highlight video, or selects an option such as “Explain this play” or “Show more details.” The terminal captures the selected event identifier and the type of request. The output is an action request indicating which highlight was chosen and what additional information the user desires.

### Step 18:

The terminal retrieves and plays the highlight video while overlaying generated text and statistics. The input is the user's selection from Step 17 and the highlight package definitions received from the server. The terminal uses the video access information to retrieve the highlight video via streaming or download. The terminal decodes and renders the video in a player area on the display. Concurrently, the terminal overlays the generated highlight description sentence and key statistical indicators, such as the updated score and a count of shots or goals for the involved competitor. The output is an integrated visual presentation of the highlight video and associated data on the terminal.

### Step 19:

The terminal optionally personalizes text via an additional prompt sentence to the generative AI model. The input is the original generated sentence from Step 12, the user attributes stored on the terminal, and the user's request from Step 17. The terminal constructs a new prompt sentence that incorporates user preferences, such as favorite group or desired tone. For example, the terminal may create: “Rewrite the following highlight description from the perspective of a supporter of Team A. Use an enthusiastic and easy-to-understand tone and keep the length under 20 words. Original description: [sentence].” The terminal sends this prompt sentence and the original description to the generative AI model and receives a personalized description. The output is a modified, user-specific highlight description sentence that the terminal can display instead of or in addition to the original text.

### Step 20:

The terminal presents personalized explanations or summaries to the user. The input is the personalized description or explanation from Step 19. The terminal updates the overlay text displayed with the highlight video or presents the personalized explanation in a separate panel. The user reads the personalized text while watching the highlight video, gaining a better understanding tailored to their interests. The output is a user interface state in which both video and AI-generated text are synchronized and adapted to the user's preferences.

### Step 21:

The user continues to interact with the terminal and the system refines processing based on behavior. The input is ongoing user interactions such as which highlights are watched, how long they are viewed, and which explanations are requested. The terminal records this behavior in local state information and may send summarized usage data to the server. The server and terminal update user attributes, importance thresholds, or selection criteria within configurable limits. Over time, the system uses this data to adjust which events are highlighted and how prompt sentences are constructed, which improves relevance and computational efficiency. The output is an adaptive configuration that influences future selection of events, generation of prompt sentences, and presentation of highlights.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional systems that analyze multimedia content and generate explanatory text using automatic speech recognition and generative models often treat each processing component as an isolated module. Audio extraction, transcription, indexing, and natural-language generation are typically executed as separate, loosely coupled steps. As a result, such systems suffer from several technical deficiencies in terms of computer technology itself.

First, existing systems are not optimized to maintain a consistent, machine-readable linkage between audio features, textual transcripts, and temporal positions within video streams. Transcripts may be stored as unstructured text without robust association to time information and identification information. This impairs the efficiency of indexing and searching operations on computing resources, increases the computational load required to locate relevant segments, and degrades responsiveness when a processor attempts to retrieve context for downstream processing.

Second, known approaches frequently construct prompts for generative models in an ad hoc manner that does not leverage structured transcript data, audio-based attention scene detection, or external event information in a unified way. Because the generation request to a generative AI model is not systematically grounded in structured information, the generative model may receive redundant or incomplete context. This leads to unnecessary data transfer, increased processing time, and higher utilization of computational resources in both local processors and remote inference hardware.

Third, systems that attempt to summarize events, such as sports games or other time-based activities, often rely on manual curation or simplistic keyword detection to identify important scenes. These methods do not efficiently exploit objective audio features, such as volume changes or other statistical characteristics, to algorithmically detect attention scenes. Consequently, the processor may need to process entire transcripts or video streams repeatedly, causing redundant computation and memory access, and reducing overall throughput of the multimedia analysis pipeline.

Fourth, conventional multimedia platforms typically do not adapt generative processing to user attributes or user states at the system level. Even when user-specific preferences are considered at the application layer, the underlying computing pipeline that generates prompts and interacts with a generative AI model remains largely static. This mismatch leads to inefficient use of model inference resources because the same generic prompts and content structures are applied to heterogeneous user requirements, forcing the system to transmit and process more information than necessary for each user.

Accordingly, there is a need for a technical solution that improves the efficiency and scalability of computer-implemented multimedia analysis and generative processing. Specifically, there is a need for a system and a processor configuration that: (i) tightly couples audio extraction, speech recognition, temporal structuring, and indexing into a coherent data model; (ii) programmatically analyzes audio features to identify attention scenes; (iii) integrates external event information into structured representations; and (iv) automatically generates prompt sentences for a generative AI model based on this structured information and user-related information. By doing so, the computer system can reduce redundant processing, improve indexing and retrieval performance, and more efficiently utilize generative inference resources, thereby providing a concrete improvement in the functioning of the underlying computer technology.

The specific processing by the specific processing unit 290 of the data processing device 12 in Example 2 is realized by the following means.

The present invention provides a server comprising a processor configured to acquire input information including video information and extract acoustic information from the input information, convert the extracted acoustic information into character information by performing an acoustic recognition process, store the character information as structured information by associating the character information with time information and identification information, index the structured information to be searchable, analyze a volume change or another statistical feature in the acoustic information to identify an attention scene, acquire competition information or event information from an external information source, automatically generate a prompt sentence for generation processing based on the structured information and the competition information or the event information, generate a processing request for a generative AI model by using the prompt sentence for generation processing and the structured information, and output a generation result acquired from the generative AI model in association with the video information based on the time information. This enables the server to implement a technically integrated multimedia processing pipeline in which audio extraction, speech recognition, temporal structuring, feature-based scene detection, external information integration, and generative model prompting are coordinated at the processor level, thereby reducing redundant data access, improving the efficiency of indexing and retrieval operations, optimizing the amount and structure of context supplied to the generative AI model, and enhancing overall computational performance and scalability of the computer system.

The term “input information” refers to information including at least video information and optionally associated metadata that is supplied to the server or processor for analysis and processing.

The term “video information” refers to digital data representing moving image content, including encoded image frames and any associated timing information.

The term “acoustic information” refers to digital data representing sound, including but not limited to voice, commentary, background noise, and other audio signals extracted from the input information.

The term “acoustic recognition process” refers to a computational process that analyzes acoustic information and converts the acoustic information into machine-readable character information using speech recognition or similar audio-to-text techniques implemented by software and executed by a processor.

The term “character information” refers to digital text data composed of characters, symbols, or tokens that represent the linguistic content derived from the acoustic information.

The term “time information” refers to temporal data indicating a position or interval in time, such as timestamps or time ranges, that can be used to associate character information or other data with specific portions of the video information or acoustic information.

The term “identification information” refers to data that uniquely or distinctively identifies an element, such as a segment of character information, a speaker, a scene, or an event, and that can be used to differentiate and reference such elements within the system.

The term “structured information” refers to character information that is organized according to a defined data model by associating the character information with time information, identification information, and optionally other attributes to enable efficient storage, indexing, and retrieval.

The term “index” refers to a data structure or arrangement created by the processor to enable efficient search and retrieval operations over structured information, for example by mapping terms or attributes to locations of corresponding records.

The term “attention scene” refers to a portion of the video information or acoustic information that is identified as being significant or noteworthy based on analysis of a volume change or another statistical feature in the acoustic information.

The term “statistical feature” refers to a quantitative characteristic derived from acoustic information, such as volume level, variance, frequency distribution, spectral features, or other computed metrics, that can be used to detect changes or patterns relevant to scene importance.

The term “competition information” refers to event-related data describing a competitive activity, such as a sports game or other organized contest, including but not limited to participant information, scores, timing, and rule-based events.

The term “event information” refers to data describing occurrences associated with the video information or acoustic information, including but not limited to game events, program segments, or other temporally defined happenings obtained from an external information source.

The term “external information source” refers to a system, service, storage device, or network resource that is separate from the server or processor and from which the processor can acquire competition information or event information.

The term “prompt sentence for generation processing” refers to a machine-readable instruction text or set of text segments that is automatically generated based on structured information and competition information or event information, and that is used to specify a task or context for a generative AI model.

The term “generative AI model” refers to an information processing model, such as a generative machine learning model, that can generate new text or other data in response to an input including a prompt sentence for generation processing.

The term “processing request for a generative AI model” refers to a structured request generated by the processor that includes a prompt sentence for generation processing and associated structured information, and that is transmitted or supplied to the generative AI model to cause execution of generative processing.

The term “generation result” refers to output data produced by the generative AI model in response to the processing request, including but not limited to explanation information, summary information, or other generated content.

The term “user attribute information” refers to information describing characteristics of a user, such as demographic attributes, domain preferences, viewing habits, or expertise level, that can influence the content or format of a prompt sentence for generation processing.

The term “user state information” refers to information describing a current condition or context of a user, such as emotional state, interaction history, session status, or current focus, that can be used to adapt the prompt sentence for generation processing.

The term “explanation information” refers to generated content that provides descriptive or interpretive text about the video information, acoustic information, or related events, based on the prompt sentence for generation processing.

The term “summary information” refers to generated content that condenses or abstracts a larger amount of information, such as an entire event or sequence, into a shorter representation that captures key points or highlights.

The term “sequentially distribute” refers to outputting or transmitting explanation information or summary information in temporal order based on the time information, such that generated content is delivered in synchronization with or in correspondence to the progression of the video information.

The server implements embodiments of the present invention by executing a set of software modules on hardware such as one or more central processing units, a main memory, a non-volatile storage device, and a network interface. The server may further use a graphics processing unit to accelerate certain numerical operations in audio processing and neural network inference. The server runs an operating system such as a general-purpose server operating system, and application software including a web server framework, a media processing library such as an audio/video processing library, an HTTP client library, and a database management system or search engine.

The server acquires input information including video information from the terminal over a communication network. The terminal operates as a client device such as a smartphone, a tablet, or a personal computer, and executes a browser or a native application to transmit video information to the server. The user operates the terminal to select video information such as sports recordings, event recordings, or other temporal multimedia content. The terminal sends the selected video information and optional metadata, such as an event category or a language label, to the server using a network protocol such as HTTPS.

The server uses a media processing library such as a command-line video/audio processing tool or a programmatic multimedia library to extract acoustic information from the received video information. The server, for example, calls a function equivalent to a media demultiplexing and decoding process to remove a video track and to convert an audio track into a uniform sampling format, such as linear pulse-code modulation at a predetermined sampling rate and channel configuration. By normalizing the sampling format at the server side, the server reduces the number of conversions that subsequent modules must perform, which improves processing throughput and reduces computational overhead.

The server converts the acoustic information into character information by executing an acoustic recognition process. The server may call an external speech recognition service, or may run an acoustic recognition model locally. In one embodiment, the server uses a neural network-based acoustic model that includes a front-end convolutional layer stack to extract spectral features from short-time Fourier transform data, a sequence modeling component such as a bidirectional recurrent unit or a transformer encoder, and a projection layer to produce symbol probabilities over a character or subword vocabulary. The server computes a loss function such as a connectionist temporal classification loss or a sequence-to-sequence cross-entropy loss during training, and updates network weights by gradient descent with back-propagation. The server may additionally use data augmentation techniques such as time masking, frequency masking, or additive noise, to increase robustness of the acoustic recognition model. By integrating a modern neural acoustic model, the server improves accuracy of speech recognition in noisy sports commentary environments compared to simpler template-based or statistical models.

The server structures the recognized character information by associating each recognized segment with time information and identification information. For example, the server maintains a relational schema or a document schema in which each record includes a video identifier, a segment identifier, a start time, an end time, a text field storing character information, and auxiliary attributes such as a speaker label or a confidence score. The server stores such structured information in a database system or a search engine index. The server builds an index such as an inverted index or a full-text search index over the text field, and maintains additional indices over time information and identification information. These data structures enable the server to retrieve text segments for specific time ranges or content keywords with fewer disk seeks and less memory scanning than unstructured log files, thereby improving retrieval speed and reducing computational load.

The server analyzes the acoustic information to identify attention scenes by computing statistical features from the audio signal. The server, for example, segments the acoustic information into frames or short windows, and calculates features such as frame energy, root-mean-square amplitude, spectral centroid, and band-limited energy. The server then computes time-series statistics such as local averages, derivatives, or z-scores over sliding windows. The server applies a rule-based detection algorithm that flags windows where the energy rises above a baseline by a threshold or where a combination of features exceeds a learned or configured boundary. In one embodiment, the server uses a small decision tree or a logistic regression model trained on annotated commentary data to classify windows into normal or excited states based on the statistical features. By performing this signal-level analysis directly on the audio, the server can detect attention scenes, such as excited commentary or crowd noise peaks, with less dependence on downstream natural language analysis and without requiring the entire transcript to be searched repeatedly. This reduces computation in the search and generation phases and yields more precise candidate regions for further processing.

The server acquires competition information or event information from an external information source such as an event information database, an application programming interface of an event organizer, or a structured data feed. The server may retrieve structured event data including participant identifiers, scores, timestamps of official events, and categorization of periods or segments. The server normalizes such external data into a unified internal representation and attaches event identifiers and time ranges that correspond to the video information. By correlating external event information with the structured transcript information and attention scenes, the server can avoid repeatedly scanning raw text to determine key highlights, which reduces processing time and improves structural alignment between human-interpretable events and the underlying multimedia data.

The server automatically generates a prompt sentence for generation processing based on the structured information and the competition information or the event information. The server assembles the prompt sentence using a template engine or a rule-based generator. For example, the server may insert selected text segments, time labels, and event metadata into predefined instruction patterns such as “Using the following transcript segments and event metadata, identify all scoring events and describe them concisely.” The server selects segments and metadata according to deterministic rules that prioritize portions marked as attention scenes or matched to important event types. In addition, the server may compute a context window size based on the density of events and the capacity of a generative AI model, so that the server transmits a compact yet sufficient set of text segments to the model. By structuring the prompt sentence generation at the server side, the system reduces the amount of redundant context transmitted to the generative AI model, thereby decreasing network bandwidth usage and processing time on the inference hardware while maintaining or improving the quality of generated outputs.

The server generates a processing request for a generative AI model by combining the generated prompt sentence with the selected structured information. In one embodiment, the server uses a generative AI model that is implemented as a transformer-based neural network having multiple self-attention layers, feed-forward layers, and positional encodings. The generative AI model has been trained on large text corpora using an autoregressive or sequence-to-sequence training objective, where the model minimizes a cross-entropy loss between predicted token distributions and ground-truth tokens. The server encodes the prompt sentence, appended with condensed transcript segments and event metadata, into tokens and sends them to the generative AI model through an inference interface. The server may use a streaming protocol to receive partial outputs as they are generated. The server enforces constraints on maximum token counts and uses system-level prompts to control the output style, such as instructing the model to return a concise summary, a list of structured events, or an explanation tailored to a certain user expertise level.

The user may provide additional instructions to the server through the terminal in the form of a prompt sentence. For example, the user may input a prompt sentence such as “Using the transcript of this soccer match, identify all goals and penalty kicks. For each event, output the match minute, the teams, the players involved, and a short description.” The user may also input a prompt sentence such as “Please summarize this basketball game in no more than 200 words. Focus on turning points, scoring runs, and the final result. Use the transcript segments where the commentator sounds excited as indicators of key moments.” The server incorporates these user-supplied prompt sentences into the generated prompt sentences by adjusting template selection, segment selection, or output format instructions. The user thus influences the behavior of the generative AI model without directly managing low-level data structures, while the server maintains control over how data are segmented, ordered, and compressed for efficient processing.

The server may further adapt the prompt sentence based on user attribute information or user state information. The server stores user attribute information, such as declared expertise level or preferred content type, in a user profile, and derives user state information, such as engagement levels or current interaction context, from interaction logs. The server then modifies portions of the prompt sentence to request more technical explanations for expert users or more narrative summaries for casual users. For example, the server may include an instruction such as “Use terminology suitable for a beginner” or “Provide tactical analysis at an advanced level.” By performing this adaptation algorithmically at the server side, the system reduces the need for the generative AI model to infer user preferences solely from ambiguous natural language, and instead provides explicit conditioning signals derived from structured user data.

The server outputs the generation result obtained from the generative AI model in association with the video information based on the time information. The server converts the model output into a structured form by parsing timestamps, event descriptions, and other extracted fields. The server aligns each generated element with corresponding time information in the video information, and stores the aligned results in the database. The terminal requests the aligned results, and the server returns them through an application programming interface.

The terminal displays text summaries, explanatory overlays, or highlight markers synchronized with the video playback timeline. The user can select a generated highlight, and the terminal instructs the video player to jump to the corresponding time in the video. This synchronization provides a concrete technical interaction between the generative processing and the multimedia playback system, rather than merely generating static text documents.

The server provides improvements in computer technology in several ways. By structuring character information with time information and identification information, and by indexing that structured information, the server reduces search complexity from linear scans over large text logs to indexed queries that can be resolved efficiently by a database engine or search engine. This decreases query response time and reduces memory and processor usage. By detecting attention scenes at the acoustic feature level, the server is able to focus subsequent processing, including generative requests, on a limited set of candidate regions, thereby reducing the volume of data transmitted to and processed by the generative AI model. This reduces communication load between the server and a remote inference service, and decreases the number of tokens or samples that the neural network must process, which directly lowers inference time and resource consumption.

The server further improves system performance by employing rule-based selection and compression of transcript segments before prompt sentence generation. Instead of transmitting entire transcripts, the server selects segments around attention scenes and relevant external events according to deterministic rules and explicit feature thresholds. This selection reduces redundancy in the input context supplied to the generative AI model. As a result, the generative AI model can concentrate its computation on salient information, which yields more accurate and coherent outputs with fewer computational steps. The causal relationship between the rule-based context selection and the improved generative quality is that the model is less likely to be distracted by irrelevant content and shorter contexts tend to produce lower perplexity on relevant segments.

The server employs a specific modular architecture in which audio preprocessing, acoustic recognition, structured indexing, attention scene detection, external event integration, prompt sentence generation, generative request orchestration, and result alignment are executed as separate modules with defined data structures. Each module uses intermediate representations that are optimized for its operation, such as fixed-length feature vectors for audio analysis, normalized event records for external data, and token sequences for generative inference. This modular design allows the server to adjust parameters of each module independently for performance tuning, such as choosing different feature sets or thresholds for different types of events, or using different prompt construction templates depending on model capacity. This goes beyond mere automation of manual tasks and constitutes a technical arrangement that improves how the computer manages multimedia data and performs complex generative tasks.

The server can implement alternative embodiments. In one variation, the server executes a local generative AI model instead of relying on a remote service. The local model runs on a graphics processing unit or tensor accelerator integrated into the server. The server stores model parameters in local memory and uses a beam search or sampling algorithm during text generation. The server can adjust decoding parameters such as temperature, top-k, or top-p thresholds to control output diversity and reliability. The server may also fine-tune the generative AI model on domain-specific transcripts of sports commentary or event broadcasts, using supervised learning to minimize cross-entropy or reinforcement learning with user feedback as a reward signal. This fine-tuning further improves the relevance and precision of generated outputs in the target domain.

In another embodiment, the server employs a hybrid approach for attention scene detection that combines acoustic features and textual features. The server begins by running the acoustic feature-based detection as described above, and then refines attention scenes by analyzing the distribution of part-of-speech tags or named entities in the transcript segments. For example, the server may detect spikes in the occurrence of certain event-related nouns or proper names around the time of an acoustic excitation. By combining these heterogeneous cues, the server obtains a more accurate set of highlights, which results in a smaller but more relevant context for the generative AI model, thereby improving both computational efficiency and output relevance.

The terminal interacts with these server-side functions by providing user interfaces for video upload, search, and generative analysis. The terminal displays prompts to the user to specify analysis goals and provides text input fields for prompt sentences. The terminal renders the generated results in association with the video playback timeline. The user thereby experiences a coherent system in which time-aligned explanations and summaries are computed and presented in near real time, supported by a backend architecture that optimizes data flow and computation.

Through these embodiments, the server implements a concrete improvement in the functioning of the computer system by transforming unstructured multimedia input into structured, indexed representations, by applying specialized algorithms for audio analysis and context selection, and by orchestrating interaction with a generative AI model in a manner that reduces computational cost while improving accuracy and responsiveness. The system is thus not a generic automation of human judgment, but a specific configuration of hardware and software components that enhances the efficiency, reliability, and scalability of multimedia processing and generative information delivery.

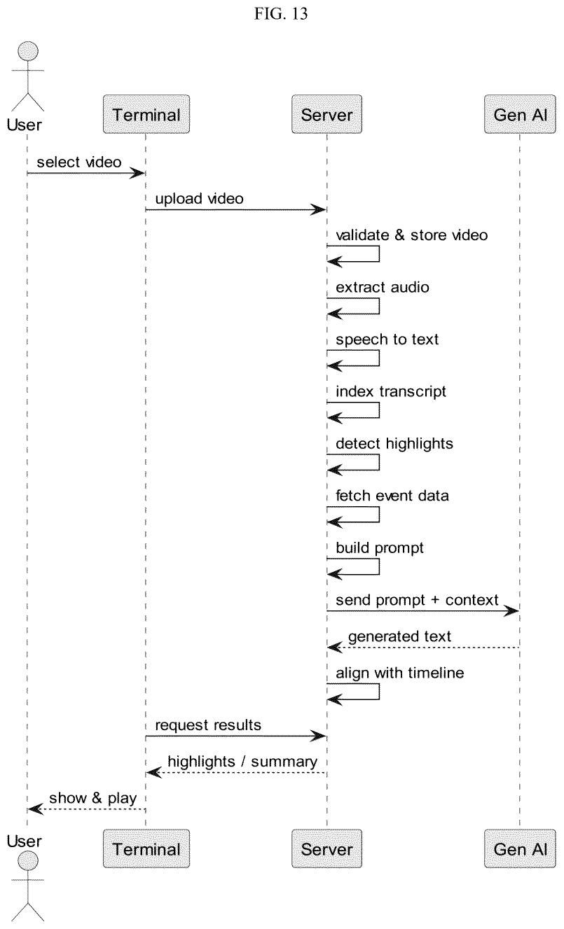

The following describes the processing flow using FIG. 13.

### Step 1:

The user selects video information on the terminal.

The terminal receives as input a user selection of a video file and optional metadata such as title, category, and language. The terminal reads the video file from local storage and packages the file and metadata into an upload request. The terminal performs data formatting and size checking, then sends the request to the server over a network connection using a protocol such as HTTPS. The output of this step is a network request containing the video data and associated metadata addressed to the server.

### Step 2:

The server receives and validates the video information.

The server takes as input the upload request from the terminal, including the video stream and metadata. The server terminates the HTTPS connection, parses the request headers and body, and writes the raw video data to a storage device such as a solid-state drive. The server executes a media inspection operation using a media processing library to analyze container format, codec types, and duration. Based on this analysis, the server checks whether the file format and duration meet predefined constraints. The server then stores a record including a video identifier, file path, and metadata in a database. The output of this step is a validated and registered video entry with a unique identifier stored in persistent storage.

### Step 3:

The server extracts acoustic information from the video information.

The server reads as input the stored video file identified by the video identifier. The server invokes a media processing library to demultiplex the container and decode the audio track. During this process, the server performs data conversion from the original audio codec into a uniform format such as linear pulse-code modulation with a specified sampling rate and channel configuration. The server writes the decoded audio stream to an audio file and updates the database to record the path of the audio file. The output of this step is acoustic information stored in an audio file that is associated with the original video identifier.

### Step 4:

The server segments and normalizes the acoustic information.

The server takes as input the audio file produced in Step 3. The server reads the audio samples and computes the duration and amplitude distribution. Based on the duration and recognition service limits, the server divides the audio into segments of predetermined length, such as several minutes each, by slicing the sample array at specific time offsets. For each segment, the server optionally applies signal normalization operations, such as gain adjustment or noise reduction, to improve the signal-to-noise ratio. The server saves each segment as a separate audio file and records its start time offset relative to the original video. The output of this step is a set of normalized audio segments with associated time offsets stored in the database.

### Step 5:

The server performs an acoustic recognition process on the audio segments.

The server uses as input each normalized audio segment produced in Step 4. For each segment, the server converts the raw waveform into acoustic features by computing a short-time Fourier transform and deriving spectral features such as mel-frequency cepstral coefficients. The server then feeds the feature sequence into a trained acoustic recognition model or sends the segment to an external speech recognition service. The model or service performs numerical operations such as matrix multiplications and non-linear activations to estimate symbol probabilities over a vocabulary, and a decoding algorithm converts these probabilities into text. The server receives the recognized text with timing information and associates it with the segment start time offset. The output of this step is character information for each segment, including recognized text and time boundaries for phrases or words.

### Step 6:

The server structures and stores the recognized character information.

The server takes as input the recognized text segments and their time information from Step 5. The server constructs structured records by combining the video identifier, segment identifier, start time, end time, text content, and optional attributes such as confidence and speaker label. The server performs data normalization, such as trimming whitespace and unifying character encoding. The server inserts these records into a database table or search index that supports efficient querying by time and text. The output of this step is structured information stored in an indexed data repository, with each text unit linked to specific time positions in the original video information.

### Step 7:

The server analyzes acoustic features to detect attention scenes.

The server uses as input the acoustic information from Step 3 or the segments from Step 4.

The server divides the audio into frames and computes statistical features for each frame, such as energy, amplitude variance, and spectral power in one or more frequency bands. The server then calculates derived statistics such as moving averages and deviations. Based on configured thresholds or a trained classifier, the server identifies frames where the feature values indicate excitement or intensity, such as a sudden rise in volume. The server groups contiguous excited frames into candidate attention scenes and records their start and end times. The output of this step is a list of attention scenes defined by time intervals associated with the video identifier.

### Step 8:

The server acquires and correlates competition information or event information.

The server takes as input the video identifier and any known event metadata from Step 2. The server connects to an external information source through a network interface and sends a query that includes parameters such as event name, date, or team identifiers. The external source returns structured data describing events, including timestamps or relative times, participants, and event types. The server maps these external event times onto the video timeline by applying offsets or synchronization marks. The server then stores correlated event records in the database with references to the video identifier and time ranges. The output of this step is a set of event records aligned in time with the structured transcript information and attention scenes.

### Step 9:

The server selects context segments for generative processing.

The server uses as input the structured transcript records from Step 6, the attention scenes from Step 7, and the event records from Step 8. The server applies selection rules that filter transcript records whose time ranges overlap attention scenes or important event types. The server computes a score for each candidate segment based on factors such as proximity to event times, magnitude of acoustic excitement, and text length. The server then selects a subset of segments that maximizes relevance while limiting the total token count. The server orders the selected segments by time and concatenates their text content, optionally inserting markers for times or events. The output of this step is a compact context text and associated metadata suitable for use in a prompt sentence.

### Step 10:

The server generates a prompt sentence for a generative AI model.

The server takes as input the compact context text and metadata from Step 9 and, optionally, a user-provided instruction from the terminal. The server applies a template generation process in which it fills predefined instruction patterns with the context text and metadata. For example, the server may generate a prompt sentence such as “Using the following transcript segments and event metadata, identify all goals and penalty kicks. For each event, output the match minute, the teams, the players involved, and a short description.” The server may also generate another prompt sentence such as “Please summarize this game in no more than 200 words. Focus on turning points, scoring runs, and the final result. Use the transcript segments where the commentator sounds excited as indicators of key moments.” During this process, the server performs string concatenation, insertion of time labels, and adaptation of wording based on user attributes or states. The output of this step is a prompt sentence and associated context text ready to be submitted to a generative AI model.

### Step 11:

The server sends a processing request to the generative AI model and receives a generation result.

The server uses as input the prompt sentence and context text from Step 10. The server tokenizes the combined text input into discrete units suitable for the generative AI model. The server packages the tokens into a request structure that includes model parameters such as maximum output length and decoding strategy. The server transmits this request to a generative AI model running locally or on a remote inference service. The generative AI model performs numerical operations, such as matrix multiplications in multiple self-attention layers, to compute probability distributions over output tokens and produces generated text. The server receives the generated text as a stream or a complete sequence, decodes tokens back into characters, and checks for structural consistency with the expected format. The output of this step is a generation result containing explanation information, summary information, or structured descriptions.

### Step 12:

The server aligns the generation result with the video information and stores it.

The server takes as input the generation result from Step 11 and the time-aligned transcript and event records from previous steps. The server parses any time references or event labels appearing in the generation result and maps them to precise time ranges using the stored time information. The server creates new records that link generated descriptions or summaries to specific time positions in the video. The server writes these records to the database, associating them with the video identifier and user identifier if applicable. The output of this step is a set of stored generative annotations that are directly linked to the video timeline.

### Step 13:

The terminal retrieves and presents the aligned generation result to the user.

The terminal uses as input an API response from the server that includes generated annotations and their associated time information. The terminal parses the response and updates the user interface to display highlight lists, summaries, or explanatory text alongside a video playback control. The terminal associates each piece of generated content with a clickable element that, when activated by the user, sends a playback command including a target time to the video player component. The user interacts with the interface to navigate to attention scenes, read explanations, or view summaries, while the terminal executes concrete control actions such as seeking the playback position and rendering overlay text. The output of this step is an interactive multimedia presentation in which generative AI outputs are synchronized with and applied to the actual video playback experienced by the user.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional content delivery systems for live sports and other real-time events primarily focus on one-way media streaming, and are not architected to integrate heterogeneous, time-sensitive data streams such as broadcast audio, event metadata, user context, and machine-generated text in a coordinated manner. As a result, these systems suffer from several technical shortcomings at the computer-system level.

First, when a server merely streams audio-visual data, a client device must decode and present the full media stream even for users who cannot rely on audio (for example, in noisy environments or when the device is muted). Existing captioning solutions typically apply offline or batch speech recognition and do not tightly align recognized text with detected highlight segments in real time. This leads to latency, misalignment between text and visual highlights, and redundant processing, thereby increasing processor load, memory usage, and network bandwidth without delivering contextually optimized output to the user.

Second, known systems that analyze sound volume or crowd noise to detect excitement generally treat such analysis as a standalone feature, not as a core component of a unified data-driven pipeline. They fail to systematically correlate detected volume peaks with structured event data (such as score changes and participant information) and do not maintain temporal associations in a way that downstream components, such as text generation engines, can exploit efficiently. Consequently, server-side applications must perform repeated database lookups and redundant computations for each user request, which degrades throughput and scalability when supporting many concurrent users.

Third, typical generative AI integrations in end-user applications are implemented at the application layer without a well-defined server-side abstraction for constructing prompt sentences from multiple synchronized signals. Application logic often composes prompts heuristically on the client side without leveraging server-maintained time-aligned mappings among recognized speech, detected highlights, external event data, and user emotion. This ad hoc composition leads to inconsistent prompt quality, variability in generated outputs, and inefficiencies due to repeated or unnecessary calls to the generative AI model.

Fourth, existing systems that incorporate user emotion information usually process such information locally on the client side, or in isolation from the media processing pipeline. They do not provide a server-level mechanism for preprocessing user voice and image data, extracting robust feature quantities, estimating emotional state, and using the estimated emotional state to systematically control style, tone, and information density of machine-generated text. This lack of integration limits the ability of the computing system to deliver emotionally adaptive outputs while maintaining deterministic and efficient server-side behavior.

Fifth, current notification systems for sports highlights typically rely on simple rule-based messages generated from score changes or event triggers, without leveraging high-level, semantically rich text generated by a generative AI model. These systems also fail to embed accurate media time information into the notification payload in a way that allows a terminal device to jump precisely to a corresponding highlight time in the media stream. As a result, users receive generic notifications and must manually seek within the video, and the underlying computer system expends extra processing cycles and network resources to deliver a less effective interaction.

Accordingly, there is a need for an improved computer-implemented system and server architecture that (i) acquires and processes media streams and associated audio signals to detect highlight sections based on volume changes, (ii) associates such highlight sections with structured external event data and temporally aligned emotion labels, (iii) constructs high-quality prompt sentences for a generative AI model from this combined information, and (iv) generates and distributes text data, including notifications and subtitles, in a way that is computationally efficient, scalable, and adaptable to user emotion. The technical problem addressed by the present invention is how to design and configure a server and associated processing pipeline so that these heterogeneous operations are integrated into a coherent, time-synchronized workflow, thereby improving utilization of computing resources, reducing redundant processing, and enhancing the responsiveness and contextual accuracy of machine-generated outputs.

The specific processing by the specific processing unit 290 of the data processing device 12 in Application Example 2 is realized by the following means.

The present invention provides a server comprising a processor configured to acquire image information relating to a sports event, extract sound information from the image information, and convert the sound information into character information by using a speech recognition technique; perform signal processing on the sound information to detect a rapid change in sound volume exceeding a predetermined threshold based on a temporal change of the sound volume, and specify time information corresponding to the detected rapid change in sound volume as a highlight section of a game; acquire game-related information including score information, group information, and participant information from an external information providing apparatus, and manage the game-related information in association with the time information; estimate an emotional state of a user based on voice information and image information acquired from a user terminal, and record the emotional state as an emotion label in association with time information; construct a prompt sentence as an input sentence for a generative AI model on the basis of the time information corresponding to the highlight section, the game-related information, and the emotion label, and create generation instruction information for using the prompt sentence as input to the generative AI model; and input the prompt sentence to the generative AI model so as to cause the generative AI model to generate text data for an information sharing service, and transmit the text data to a terminal device as notification data or subtitle data. This enables the server to integrate media processing, event detection, external data acquisition, emotion estimation, and prompt-based generative text creation into a unified, time-synchronized pipeline, thereby improving computational efficiency, reducing latency and redundant processing, and providing contextually accurate, emotion-adaptive notifications and subtitles that can be used by terminal devices to present highlight sections and related information in a more responsive and user-relevant manner.

The term “image information” refers to digital data representing visual content of an event, including still or moving pictures, frames, or any encoded video signals obtained from a capture device or a distribution source.

The term “sports event” refers to a competitive or cooperative physical activity involving at least one group of participants, such as a match, game, race, or tournament, that progresses over time and can be observed through media.

The term “sound information” refers to digital or analog data representing acoustic signals associated with image information, including commentary, crowd noise, ambient sounds, and any other audio components extracted from a media stream.

The term “speech recognition technique” refers to a computational method or algorithm that analyzes sound information and outputs corresponding character information, typically by applying pattern recognition, statistical modeling, or machine learning to map acoustic features to linguistic units.

The term “character information” refers to text data composed of characters, symbols, or words that are produced by converting sound information using the speech recognition technique and that can be stored, processed, or displayed by an information processing apparatus.

The term “signal processing” refers to operations performed on sound information or other time-series data, such as filtering, frame segmentation, feature extraction, and statistical analysis, in order to detect patterns, changes, or specific events.

The term “rapid change in sound volume” refers to a variation in amplitude or loudness of the sound information that exceeds a predetermined rate or magnitude of change within a specified time interval.

The term “predetermined threshold” refers to a reference value or criterion, which may be fixed or adaptively determined, used to judge whether a measured parameter such as sound volume change or similarity score is significant enough to trigger a particular decision or detection.

The term “time information” refers to data indicating a temporal position or interval within a media sequence, such as timestamps, frame numbers, or timecodes, that can be used to align image information, sound information, or other data streams.

The term “highlight section” refers to a segment of a sports event identified by time information as having particular importance or excitement, often characterized by a rapid change in sound volume or a significant game event such as scoring.

The term “game-related information” refers to structured data describing the state or progression of a sports event, including but not limited to score information, group information, and participant information.

The term “score information” refers to data indicating quantitative outcomes or points obtained by groups or participants in a sports event, including current scores, changes in scores, and scoring events.

The term “group information” refers to data describing collectives or entities participating in a sports event, such as teams, clubs, or organizations, including identifiers, names, and related attributes.

The term “participant information” refers to data describing individual entities involved in a sports event, such as players, competitors, or officials, including identifiers, roles, statistics, and performance attributes.

The term “external information providing apparatus” refers to any device, server, or system, accessible via a communication network, that supplies game-related information or other structured data to the server.

The term “user terminal” refers to an information processing device operated by an end user, such as a portable terminal, a stationary terminal, or a head-mounted display, that is capable of capturing user data and receiving content or notifications.

The term “voice information” refers to audio data representing vocal sounds produced by a user, including speech and non-speech vocalizations, captured by a sound input device such as a microphone.

The term “image information acquired from a user terminal” refers to visual data such as images or video sequences capturing a user, including facial expressions or body movements, obtained by an image input device such as a camera on the user terminal.

The term “emotional state” refers to a psychological condition or affective status of a user, such as excitement, happiness, sadness, surprise, or disappointment, inferred from analysis of user-related data.

The term “emotion label” refers to a symbolic representation or category assigned to an estimated emotional state, typically expressed as a discrete label or code stored in association with time information.

The term “prompt sentence” refers to a textual input sequence provided to a generative AI model, describing conditions, context, or instructions that guide the generation of output text data.

The term “generative AI model” refers to an information processing model, typically implemented by machine learning or artificial neural networks, that receives input data including a prompt sentence and produces new text data or other content based on learned patterns.

The term “generation instruction information” refers to control data specifying how a generative AI model is to be invoked, including at least the prompt sentence and, optionally, parameters such as desired style, tone, or length of the generated text.

The term “text data” refers to machine-processable data consisting of character strings or natural language sentences generated by the generative AI model, suitable for presentation to a user or further processing.

The term “information sharing service” refers to a network-based platform or application that allows users to post, distribute, or view content, including text data, to or from other users.

The term “notification data” refers to text data and associated control information intended to be delivered to a user terminal as an alert or message, typically presented in a notification interface or similar user interface component.

The term “subtitle data” refers to text data that is temporally synchronized with image information and intended to be overlaid on a display area during playback of the image information.

The term “feature quantity” refers to a numerical or symbolic value extracted from raw data, such as acoustic features from voice information or geometric features from image information, used as input to an estimation or classification algorithm.

The term “style of the prompt sentence” refers to characteristics of language use in the prompt sentence, such as formality level, sentence structure, and narrative perspective.

The term “tone of the prompt sentence” refers to the affective or attitudinal quality expressed by the prompt sentence, such as enthusiastic, neutral, sympathetic, or analytical.

The term “amount of information of the prompt sentence” refers to the extent or richness of content included in the prompt sentence, such as the number of facts, level of detail, or contextual descriptions provided.

The term “highlight information” refers to a subset of text data or associated metadata that describes or represents a highlight section, including a summary of the event and related contextual details.

The term “notification message” refers to a data structure including highlight information, time information, and optional additional data, formatted for delivery to and display on a user terminal as an alert or message.

The term “terminal device” refers to an information processing apparatus, including but not limited to a user terminal, that receives data such as text data, notification data, or subtitle data from a server and performs output or further processing.

In one embodiment, a server, one or more terminals, and a communication network together implement the system. The server includes at least one processor, a main memory, a non-volatile storage device, and a network interface. The terminal includes at least one processor, a display, a camera, a microphone, and a network interface. The server and the terminal execute programs stored in their respective memories to realize the functions described below.

The server uses a video capture interface or streaming receiver to acquire image information relating to a sports event. The server receives a digital video stream from a broadcasting apparatus or a distribution platform through a network using, for example, an HTTP-based streaming protocol. The server stores the received stream in a storage device as a sequence of encoded frames together with associated timecodes.

The server uses media processing software, such as a general-purpose video/audio processing library, to demultiplex the encoded stream. The server separates image information and sound information by parsing stream headers and payloads and writes the sound information into an audio buffer in a standardized format, such as linear PCM at a predetermined sampling rate and bit depth. The server maintains an index table that associates each audio buffer segment with corresponding time information in the image information.

The server applies a speech recognition technique to the sound information. The server converts each audio buffer segment into an acoustic feature sequence by computing feature quantities such as Mel-frequency cepstral coefficients, spectral energies, and delta coefficients. The server normalizes the feature sequence and inputs it to a speech recognition model. In one embodiment, the server uses a neural network-based automatic speech recognition model comprising a convolutional layer, a recurrent layer, and a connectionist temporal classification output layer. The server obtains character information representing commentary or other speech contained in the sound information. The server stores, in a text database, the character information together with start and end time information and a reliability score output by the speech recognition model.

The server performs signal processing on the sound information to detect a rapid change in sound volume. The server segments the sound information into short frames of a fixed length, such as 10 milliseconds, and computes, for each frame, an energy value or a root-mean-square amplitude value. The server stores the energy values as a time series in a ring buffer or a time-indexed array. The server calculates, for each frame, a derivative of the energy value with respect to time and compares the derivative with a predetermined threshold stored in a configuration table. When the derivative exceeds the threshold, the server detects a rapid change in sound volume. The server then groups consecutive frames exhibiting rapid change into an event segment and determines time information indicating a start time and an end time of the event segment. The server records the time information as a highlight section in an event table.

The server acquires game-related information from an external information providing apparatus. The server transmits a request over a network using a standardized protocol, including a match identifier and authentication information, and receives structured data, such as a hierarchical data object, indicating score information, group information, and participant information. The server parses the structured data and extracts items corresponding to scoring events, team identifiers, and player identifiers. The server stores the game-related information in a relational database, associating each game event with a timestamp. The server aligns the time information of the highlight section with the timestamps of the game-related information by comparing time values and selecting game events whose timestamps fall within a tolerance range around the highlight section.

The terminal captures voice information and image information from a user while the user is viewing the sports event. The terminal uses the microphone to sample the user's voice at a predetermined sampling rate and stores the audio samples in a local buffer. The terminal uses the camera to capture images of the user's face at a predetermined frame rate and stores the image frames in a local buffer. The terminal may down-sample the audio or reduce the image resolution to limit bandwidth. The terminal transmits the buffered voice information and image information to the server through a secure communication channel.

The server preprocesses the voice information and the image information to estimate an emotional state of the user. The server extracts acoustic feature quantities from the voice information, such as pitch, energy, formants, and speaking rate. The server extracts visual feature quantities from the image information, such as facial landmark positions, eye openness, mouth curvature, and head pose, using an image analysis library. The server concatenates or otherwise fuses the acoustic feature quantities and the visual feature quantities to form a multimodal feature vector. The server inputs the multimodal feature vector into an emotion estimation model.

In one embodiment, the server uses a neural network for emotion estimation. The neural network includes an input layer receiving the multimodal feature vector, one or more hidden layers implemented as fully connected layers or recurrent layers, and an output layer that outputs a probability distribution over a finite set of emotion labels such as “excited,” “calm,” “disappointed,” and “surprised.” The server uses a softmax function at the output layer and computes a cross-entropy loss during training. During operation, the server selects, as the emotion label, the class having the highest probability exceeding a threshold. The server records the emotion label and an associated confidence value in association with time information corresponding to the user's viewing time.

The server constructs a prompt sentence as an input sentence for a generative AI model on the basis of the time information corresponding to the highlight section, the game-related information, and the emotion label. The server retrieves, from the database, the score information, group information, and participant information corresponding to the highlight section. The server retrieves, from the text database, the character information generated by the speech recognition technique for the same time range. The server retrieves, from the emotion table, the emotion label corresponding to the user's viewing time. The server combines these data components according to a predetermined template stored in a prompt configuration module.

In one example, the server constructs a prompt sentence as follows:
“User emotion: excited.
Event: soccer match.
Current score: Team A 2-Team B 1.
Latest event: Player B scored a goal at 67 minutes.
Crowd reaction: very loud cheer detected.
Task: As a fan, generate a short, enthusiastic social media post about this moment. Mention the score and Player B's goal.”

In another example, when the emotion label is “disappointed,” the server constructs a prompt sentence as follows:
“User emotion: disappointed.
Event: soccer match.
Current score: Team A 1-Team B 2.
Latest event: Team A conceded a goal.
Task: Generate a short, sympathetic social media post that acknowledges the setback but stays supportive. Do not sound overly cheerful.”

The server creates generation instruction information containing the prompt sentence and parameters for the generative AI model, such as a maximum output length, a randomness parameter, and constraints on including certain fields. The server transmits the generation instruction information to the generative AI model.

In one embodiment, the generative AI model is a neural network-based language model, such as a transformer architecture including a plurality of self-attention layers, feedforward layers, and normalization layers. The generative AI model has been trained in advance on a large corpus of text using an objective function including next-token prediction and regularization terms. During inference, the server encodes the prompt sentence into token indices, inputs the indices to the generative AI model, and obtains, for each token position, a probability distribution over candidate output tokens. The server selects output tokens according to a decoding strategy, such as greedy decoding, top-k sampling, or nucleus sampling, so as to generate text data as a sequence of natural language tokens.

The server receives the text data from the generative AI model and verifies that required elements, such as mention of the score or participant, are present. When necessary, the server slightly modifies the prompt sentence and requests a new output to satisfy application constraints. The server classifies the text data as notification data or subtitle data according to the intended use. For notification data, the server may shorten the text to fit into a notification format and attach highlight information and time information. For subtitle data, the server associates the text data with time information and converts it into a subtitle format, such as a structured sequence of caption entries.

The server transmits the text data to the terminal through the communication network. For notification data, the server uses a push notification service and includes the time information and highlight information in a payload. For subtitle data, the server exposes an endpoint from which the terminal can periodically obtain updated subtitle segments.

The terminal receives notification data and displays a notification message on a screen. The terminal analyzes the time information included in the notification message and, upon a user's selection, requests playback of image information from the server starting at a time indicated by the time information. The terminal receives the corresponding portion of the image information and begins playback from the highlight section without requiring the user to search manually. The terminal receives subtitle data and overlays the subtitle text on the image information on the display in synchronization with the timecodes.

By organizing processing in this manner, the server reduces redundant computations and network transfers. The server performs speech recognition and volume-based highlight detection only once per stream and stores time-aligned results so that multiple terminals can share the same processed information. The server associates game-related information, emotion labels, and highlight sections using specific data structures, such as relational tables keyed by time and identifiers, so that constructing a prompt sentence does not require repeated expensive queries. This improves processing speed and reduces database load.

The server improves the quality and consistency of prompt sentences by using structured templates and explicit inclusion of time information, emotion labels, and game-related information. This differs from conventional systems where a client or user manually writes a free-form instruction. By generating prompt sentences programmatically based on structured data, the server achieves a more stable distribution of input patterns to the generative AI model, leading to improved output stability, reduced variance in response quality, and reduced need for manual correction. This constitutes an improvement of the computer-implemented text generation pipeline rather than a mere automation of human text composition.

The emotion estimation model and the highlight detection logic implement decision rules that differ from human heuristics. For example, the server may define a non-linear mapping between energy derivatives and highlight likelihood, and may require concurrence between a detected rapid change in sound volume and a significant game-related event before marking a highlight section. The emotion estimation model combines multi-modal feature quantities in a high-dimensional feature space using learned weight parameters, not a simple rule-based mapping. This allows the system to identify emotional states and highlight sections with higher accuracy and robustness than manual observation. These technical configurations reduce false positives and false negatives in highlight detection and emotion estimation, directly improving the precision of downstream text generation and notification functions. The training of the emotion estimation model and the generative AI model involves specific technical procedures. The server or a separate training apparatus uses labeled training data consisting of voice information, image information, and emotion labels. The training system defines a loss function, such as cross-entropy between predicted emotion probabilities and ground-truth labels, and updates the network's weight parameters using an optimization algorithm such as stochastic gradient descent with momentum or an adaptive gradient method. The training system performs data augmentation, such as random pitch shifting or adding background noise to voice information and random cropping or horizontal flipping of face images, to improve generalization and robustness. The resulting neural network parameters are deployed on the server and used in inference mode to process live data. By defining these specific training and inference pathways, the system realizes a concrete improvement in classification accuracy and robustness.

The described architecture achieves technical effects beyond simple automation of human mental processes. The server optimizes memory usage by organizing audio frames, energy values, transcripts, and emotion labels in time-indexed data structures, reducing the need to re-scan large data files for each user request. The server reduces communication load by transmitting only relevant text data, notification data, and highlight-related segments instead of the entire media stream. The server improves responsiveness because constructing a prompt sentence from pre-indexed data is faster than constructing a prompt from raw logs at request time. Furthermore, the combination of volume-based detection, structured event mapping, and emotion-controlled prompt sentence generation yields machine-generated outputs that are temporally precise and contextually aligned in a way that conventional ad hoc systems do not achieve.

The system may be modified in various ways without departing from the scope of the claims. In another embodiment, the terminal executes part of the emotion estimation processing locally, using an on-device neural network to estimate a coarse emotion label and transmitting only the label and a confidence score to the server. In another embodiment, the server uses an alternative generative AI model, such as a recurrent neural network-based language model or a different transformer configuration, while still constructing prompt sentences from time-aligned highlight sections, game-related information, and emotion labels. In another embodiment, the server extends the concept of a highlight section to non-sports events, such as concerts or presentations, by using volume changes and externally provided event markers as detection cues.

In all of these embodiments, the server, the terminal, and the processing pipeline are configured so that heterogeneous data streams—media signals, structured event data, user emotion data, and generative text data—are integrated in a technically specific manner. This integration improves processing speed, accuracy, and resource utilization inside the computer system and enables terminal devices to present highlight sections and related text in a technically advantageous way.

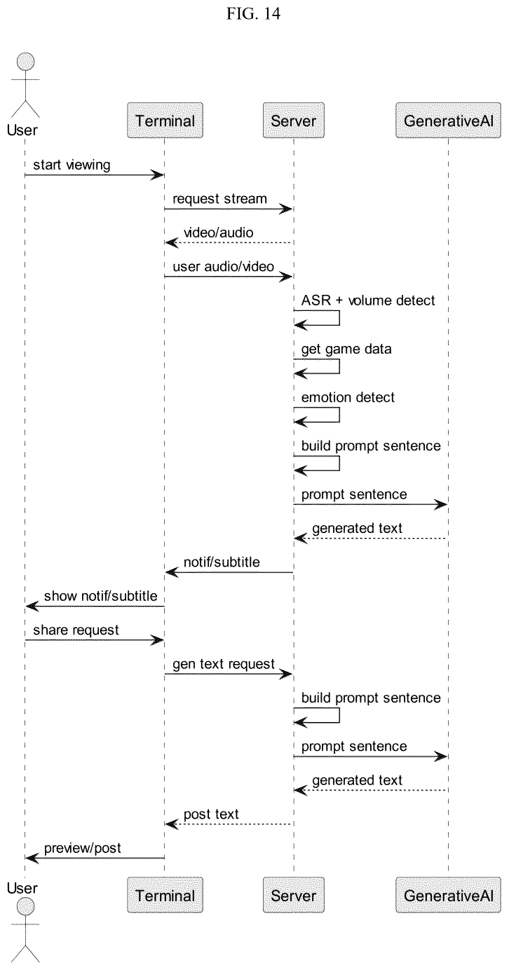

The following describes the processing flow using FIG. 14.

### Step 1:

Server acquires image information and sound information from a media source.

Server receives, as input, a digital media stream including encoded image frames and an audio track from a broadcasting apparatus or a distribution platform via a network protocol. Server parses container headers, demultiplexes the stream into separate video and audio elementary streams using a media processing library, and writes the image information and sound information into respective buffers together with timecodes.

Server outputs a time-indexed video buffer and an audio buffer in a standardized format that can be used by subsequent processing modules.

### Step 2:

Server performs speech recognition on the sound information.

Server takes, as input, the audio buffer produced in Step 1 and divides the audio into overlapping or non-overlapping segments of fixed duration, such as 5 to 10 seconds, based on timecodes.

Server computes acoustic feature quantities for each segment, such as Mel-frequency cepstral coefficients, log-mel filterbank energies, and temporal derivatives, and normalizes these features.

Server inputs the feature sequences to a speech recognition model implemented as a neural network and receives, as an output, character information (transcripts) with associated start and end times and confidence scores for each recognized utterance.

Server stores the transcripts and their time information in a text database, thereby producing time-aligned character information suitable for subtitle generation.

### Step 3:

Server detects rapid changes in sound volume to identify candidate highlight sections.

Server takes, as input, the same audio buffer used in Step 2 and segments it into short analysis frames, for example 10-millisecond or 20-millisecond windows.

Server calculates, for each frame, an energy value or a root-mean-square amplitude, then constructs a time-series array of these values.

Server computes the difference in energy between consecutive frames and compares the difference to a predetermined threshold stored in configuration data; when the difference exceeds the threshold, the server marks the corresponding time as a rapid change in sound volume.

Server aggregates adjacent frames with rapid changes into contiguous segments, determines start and end time information for each segment, and outputs a list of candidate highlight sections defined by time intervals.

### Step 4:

Server associates highlight sections with game-related information.

Server takes, as input, the list of candidate highlight sections from Step 3 and an external game identifier for the sports event.

Server transmits a request to an external information providing apparatus, including the game identifier, and receives structured game-related information, such as score changes, group identifiers, and participant identifiers, each tagged with timestamps.

Server matches each highlight section's time interval with one or more game events whose timestamps fall within or near that interval, using a tolerance window, and writes association records into a database.

Server outputs enriched highlight entries containing both time information and corresponding game-related information, such as “goal scored by a particular participant at a specific score.”

### Step 5:

Terminal captures user voice information and image information during viewing.

Terminal receives, as input, a user action to start viewing and begins capturing sensor data. Terminal activates a microphone to sample the user's voice at a predetermined sampling rate and stores audio samples in a local audio buffer, and activates a camera to capture frames of the user's face at a predetermined frame rate and stores image frames in a local image buffer.

Terminal may down-sample audio and reduce image resolution to meet bandwidth constraints, then encrypts and transmits the buffered voice information and image information to the server via a secure communication channel.

Terminal outputs a continuous stream of user-related sensor data to the server.

### Step 6:

Server estimates an emotional state of the user from multimodal features.

Server takes, as input, the voice information and image information received from the terminal in Step 5.

Server extracts acoustic feature quantities, such as pitch contour, energy, and spectral tilt, from the voice information, and visual feature quantities, such as facial landmarks, eye openness, and mouth curvature, from the image information.

Server concatenates or otherwise fuses these acoustic and visual feature quantities into a multimodal feature vector for each analysis time window.

Server inputs each multimodal feature vector to an emotion estimation neural network, which outputs a probability distribution over predefined emotion labels; server selects the emotion label with the highest probability above a confidence threshold.

Server associates the selected emotion label and its confidence value with corresponding time information and outputs an emotion record, such as “excited at time T,” into an emotion table.

### Step 7:

Server aggregates highlight information, game-related information, transcripts, and emotion labels.

Server takes, as input, enriched highlight entries from Step 4, time-aligned character information from Step 2, and emotion records from Step 6.

Server, for each highlight section, queries its databases to retrieve transcript segments whose time intervals overlap the highlight interval, retrieves associated game-related events (for example, score changes and participant actions), and finds emotion labels recorded near the time when the user viewed the highlight.

Server compiles, for each highlight, a combined record containing fields such as start time, end time, score before and after the event, participant identifiers, key phrases from the commentary, and one or more emotion labels.

Server outputs a structured highlight context object that serves as a basis for constructing a prompt sentence.

### Step 8:

User initiates generation of a context-aware text output.

User interacts with the terminal and selects an option to generate a post or description relating to the current highlight or event.

User may input additional preferences, such as language, desired tone, or length, via a user interface element; these preferences are captured as text settings or selection values.

User confirms that the system may use the current highlight context and the user's emotional state for text generation.

User's action causes the terminal to send a generation request containing user preferences and an identifier of the target highlight to the server.

### Step 9:

Server constructs a prompt sentence for the generative AI model.

Server takes, as input, the highlight context object from Step 7 and the generation request from Step 8.

Server selects a prompt template based on the user's emotion label and preferences; for example, the server selects an “enthusiastic” template if the emotion label is “excited” and a “sympathetic” template if the emotion label is “disappointed.”

Server fills the template with data from the highlight context object, including score information, group names, participant names, and a textual description of the detected crowd reaction, as well as the emotion label.

Server outputs a prompt sentence that describes the context and instructs the generative AI model, for example:
“User emotion: excited.
Event: soccer match.
Current score: Team A 2-Team B 1.
Latest event: Player B scored a goal at 67 minutes.
Crowd reaction: very loud cheer detected.
Task: As a fan, generate a short, enthusiastic social media post about this moment. Mention the score and Player B's goal.”

### Step 10:

Server invokes the generative AI model to produce text data.

Server takes, as input, the prompt sentence generated in Step 9 and generation parameters, such as desired maximum length and randomness level.

Server encodes the prompt sentence into token indices according to a vocabulary of the generative AI model and submits the token sequence to the model through a model interface or a remote inference API.

Server receives, as output from the generative AI model, a sequence of tokens representing text data, for example a natural language sentence describing the highlight in a style consistent with the prompt sentence.

Server decodes the tokens into a character string, performs simple post-processing such as trimming whitespace and verifying the inclusion of required elements, and outputs finalized text data suitable for display or transmission.

### Step 11:

Server classifies and formats the generated text data as notification data or subtitle data.

Server takes, as input, the text data from Step 10 and the type of output requested in Step 8.

Server, when notification output is requested, constructs notification data by truncating or summarizing the text if necessary, appending highlight information and time information, and formatting the result in a notification structure compatible with a notification delivery service.

Server, when subtitle output is requested, associates the text data with specific time information for display during playback, splits longer text into multiple caption entries, and formats these entries into a subtitle data structure with start and end times.

Server outputs notification data or subtitle data, each including the generated text and associated metadata.

Step 12:

Server delivers text data to the terminal over the network.

Server takes, as input, notification data or subtitle data created in Step 11.

Server, in the case of notification data, transmits the notification data to a push notification service along with user and device identifiers so that the notification can be routed to the correct terminal.

Server, in the case of subtitle data, exposes an endpoint and pushes or makes available the subtitle segments associated with the current or upcoming time intervals, allowing the terminal to retrieve them asynchronously.

Server outputs network messages carrying the text data to the terminal, thereby making the generated outputs available on user devices.

### Step 13:

Terminal presents notification messages and controls playback based on time information.

Terminal takes, as input, notification data received in Step 12, including highlight information and time information.

Terminal displays the notification message in a system notification area or within the application and waits for user interaction.

Terminal, when the user taps or selects the notification, sends a playback request to the server specifying the time information associated with the highlight section.

Terminal receives from the server a video stream starting from the specified time and outputs synchronized audio and video to its display, allowing the user to watch the highlighted moment without manual seeking.

### Step 14:

Terminal overlays subtitle data on image information.

Terminal takes, as input, subtitle data received from the server and the video stream being displayed.

Terminal parses subtitle entries, each including start and end times and associated text, and converts the time information to the local playback clock used by the video player component.

Terminal renders subtitle text as an overlay at the bottom of the screen and updates or clears the overlay as the playback time passes each entry's start and end times.

Terminal outputs, on the display, image information and synchronized subtitle text so that the user can understand commentary and AI-generated descriptions even when audio is muted or difficult to hear.

### Step 15:

User reviews and optionally edits AI-generated text before sharing.

User views, on the terminal, the text data generated in Step 10 and formatted in Step 11, for example within a preview area of the application.

User optionally modifies the text, adds personal comments, or adjusts hashtags and other elements using a text editing interface on the terminal.

User confirms the final version of the text and selects a target information sharing service for posting.

User's confirmation causes the terminal to send a publication request, containing the final text and destination platform information, to the appropriate service interface.

### Step 16:

Terminal posts the finalized text to an information sharing service.

Terminal takes, as input, the final text approved by the user in Step 15 and relevant authentication information for the selected service.

Terminal uses an application programming interface provided by the information sharing service to transmit the text and associated metadata, such as media links or highlight identifiers, and receives a response indicating success or failure.

Terminal, upon success, may display a confirmation message and optionally a link or identifier for the posted content.

Terminal outputs a user-visible indication that the context-aware, AI-assisted text has been shared, completing the end-to-end flow from highlight detection through prompt sentence construction, generative AI model invocation, and user-controlled publication.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

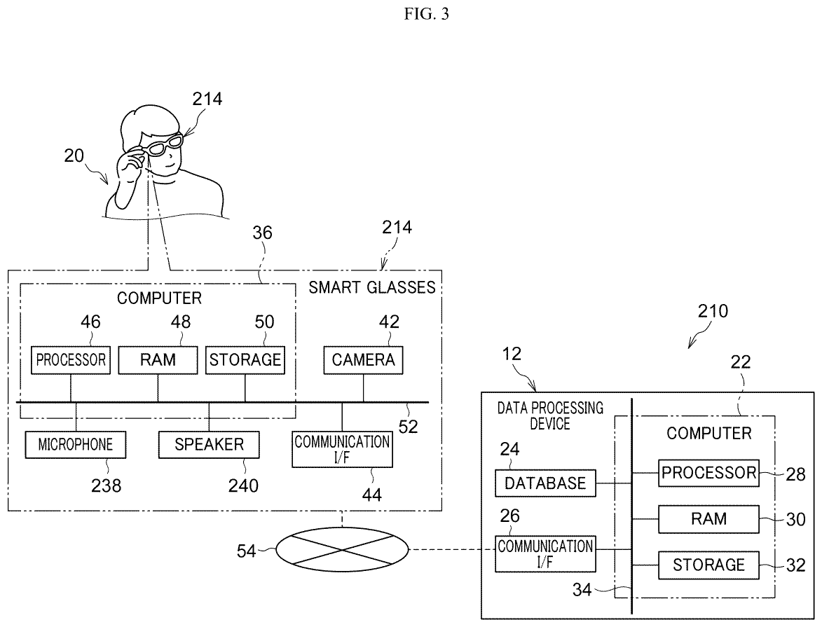

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

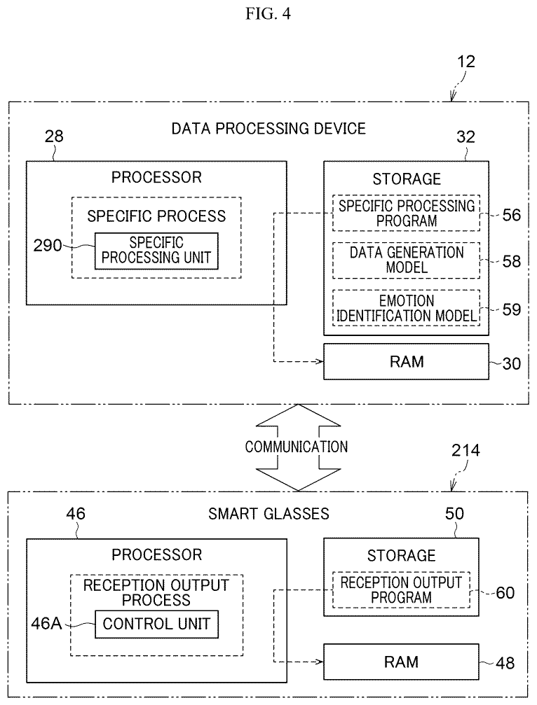

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

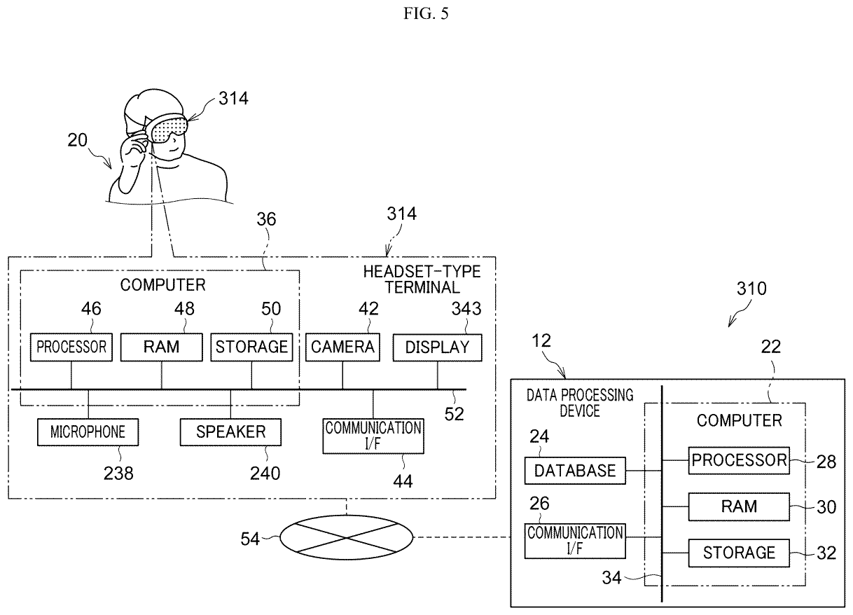

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

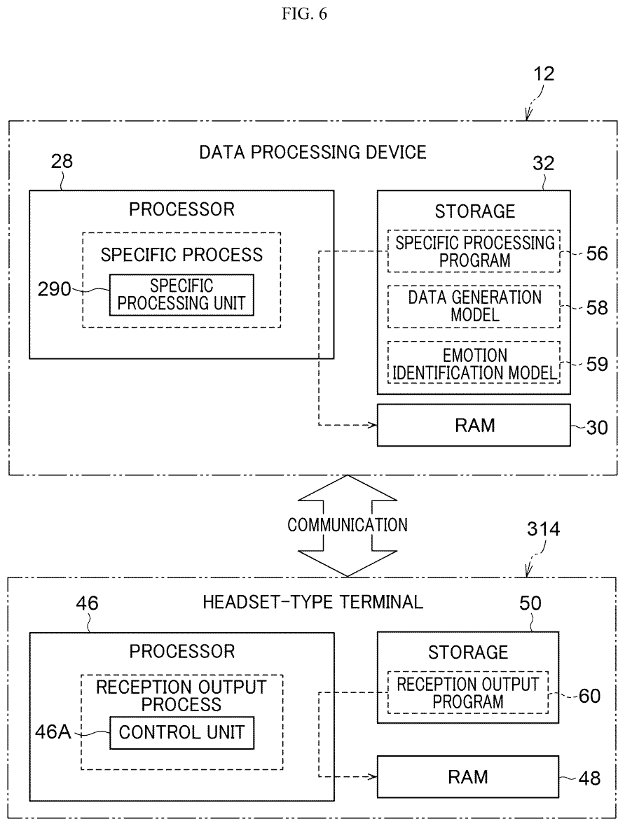

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

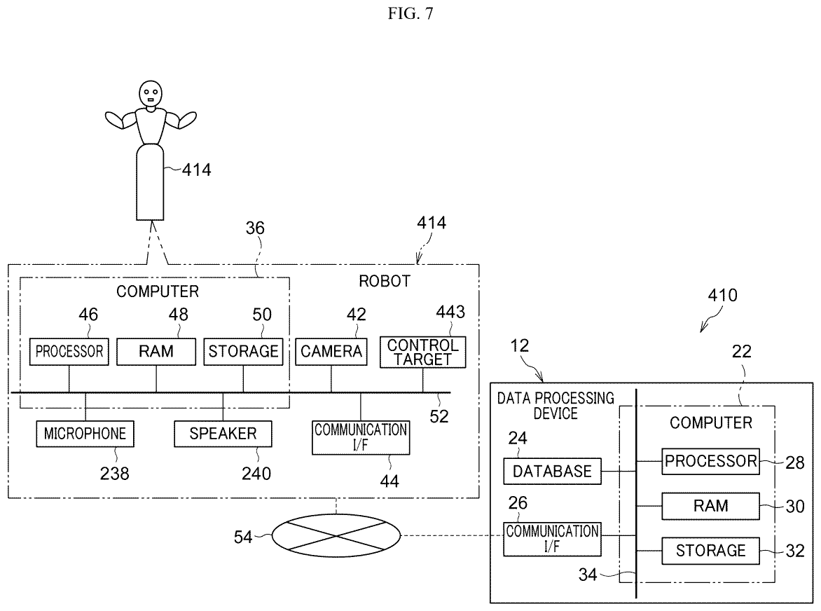

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

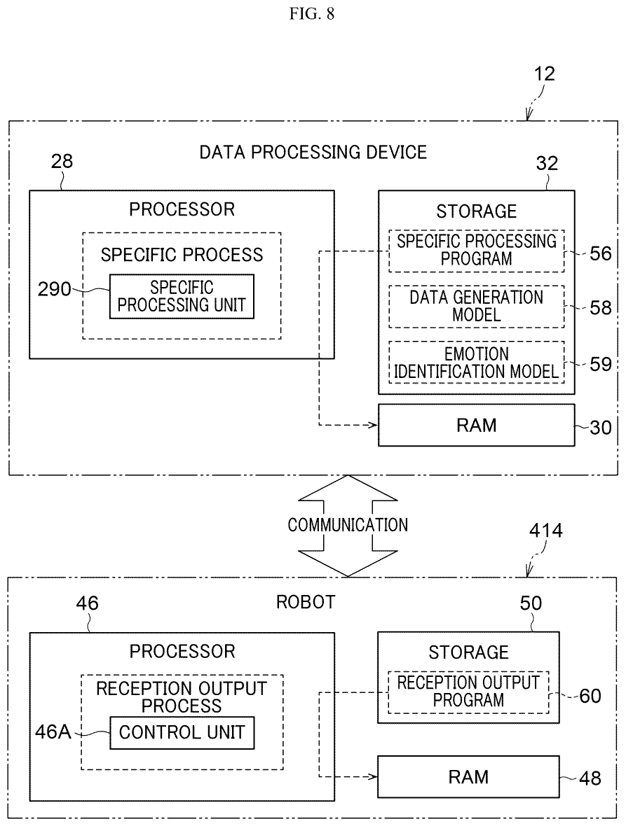

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

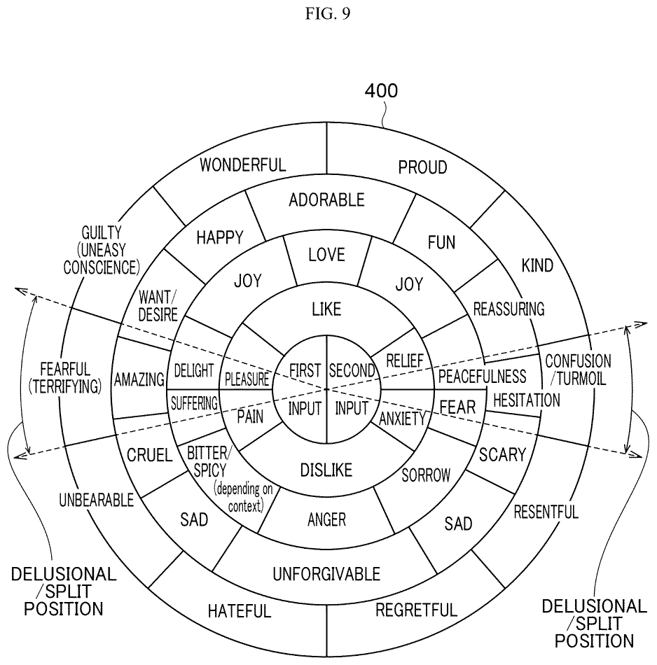

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

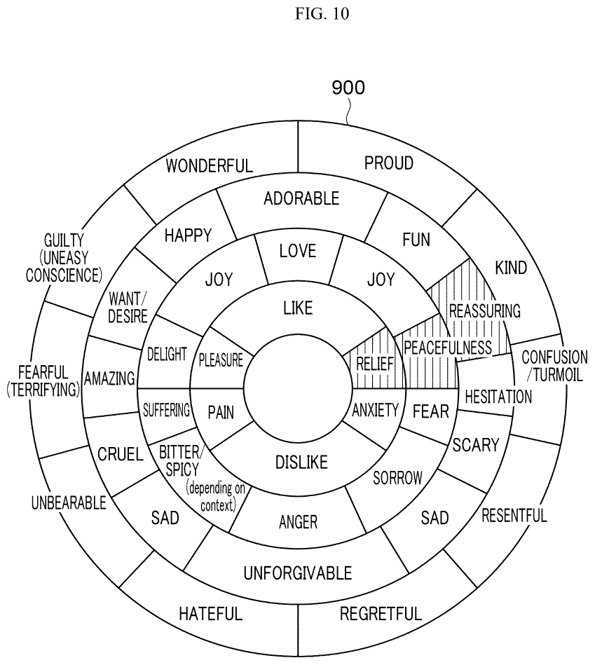

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
receive a video input signal including a broadcast signal or a distribution signal and acquire sports relay video; and
separate an audio signal included in the sports relay video and generate audio data as an analysis target; and
execute speech recognition processing on the audio data and generate character information with time information; and
calculate a temporal change of an acoustic quantity based on the audio data, detect a change of the acoustic quantity that satisfies a predetermined condition, and specify time information of an excitement event; and
acquire match information, group information, and participant information from an external information source, associate the acquired information with the time information of the excitement event and the character information, and generate structured data; and generate a prompt sentence, including instructions relating to a match situation, event content, and an output format, on the basis of the structured data; and
input the prompt sentence to a generative AI model, cause the generative AI model to generate a natural language document, and record the generated natural language document as related information in association with the time information of the excitement event and with a section of the sports relay video; and
continuously distribute the sports relay video to a terminal device and transmit the related information to the terminal device for use in display control or playback control.

### (Supplementary 2)

The system according to supplementary 1,
wherein the processor is configured to estimate an emotional state of a user on the basis of operation information of the user or detection information relating to the user, and change an instruction content or a style condition included in the prompt sentence in accordance with the estimated emotional state.

### (Supplementary 3)

The system according to supplementary 1,
wherein the processor is configured to synchronize the natural language document generated by the generative AI model with the time information of the excitement event, superimpose the natural language document on distribution data to be transmitted, and provide the natural language document in a format capable of being presented in real time by the terminal device.

### Application Example 1

### (Supplementary 1)

A system comprising a processor,
wherein the processor is configured to
acquire a broadcast video signal of a sports event, separate an audio signal from the broadcast video signal, and convert the separated audio signal into data in a format suitable for acoustic analysis processing and speech recognition processing,
calculate volume information in a time domain or a frequency domain for the audio signal, detect a sudden change in the volume based on a predetermined criterion, and identify time information corresponding to an exciting portion of a match based on a result of the detection,
apply a speech recognition process to the audio signal to generate character information, and extract predetermined words or expressions from the character information to evaluate an importance level of the exciting portion,
identify a scoreboard region or a display region from the broadcast video signal by image processing and character recognition processing, acquire score information, group information, competitor information, and time information of the match from the region, and/or acquire match information from an external information source,
integrate the exciting portion based on the volume change, the character information, the match information, and the time information to generate and store structured data for each event, the structured data including at least an event type, a related group, a related competitor, a score change, and the importance level,
select, based on the structured data, an important moment of the match, statistical information, and a video section corresponding to the important moment, and dynamically generate a prompt sentence to be input to a generative AI model,
input the prompt sentence and the structured data to the generative AI model, cause the generative AI model to generate at least one of a highlight description sentence, a match summary sentence, and an explanatory sentence, and associate and store a generated sentence with the structured data and the video section, and
determine a clipping range for the video section by referring to the structured data, generate a highlight video, and associate the highlight video with the generated sentence and the statistical information to generate distribution data or output data.

### (Supplementary 2)

The system according to supplementary 1,
wherein the processor is configured to
cause a display device for a user to display a list in which the highlight video, the generated sentence, and the statistical information are arranged in chronological order, and, in response to a selection operation by the user, reproduce a corresponding highlight video while superimposing and displaying the generated sentence and the statistical information.

### (Supplementary 3)

The system according to supplementary 1,
wherein the processor is configured to
determine a user attribute including at least one of a detail level of explanation, a writing style, a focused group, and a focused competitor, based on an input operation from the user or state information of the user, and change the prompt sentence to be input to the generative AI model according to the user attribute to cause the generative AI model to generate a personalized highlight description sentence or match summary sentence.

### Example 2

### (Supplementary 1)

A system comprising a processor,
wherein the processor is configured to
acquire input information including video information and extract acoustic information from the input information, and
convert the extracted acoustic information into character information by performing an acoustic recognition process, and
store the character information as structured information by associating the character information with time information and identification information, and index the structured information to be searchable, and
analyze a volume change or another statistical feature in the acoustic information to identify an attention scene, and
acquire competition information or event information from an external information source, and
automatically generate a prompt sentence for generation processing based on the structured information and the competition information or the event information, and
generate a processing request for a generative AI model by using the prompt sentence for generation processing and the structured information, and
output a generation result acquired from the generative AI model in association with the video information based on the time information.

### (Supplementary 2)

The system according to supplementary 1,
wherein the processor is configured to
acquire user attribute information or user state information, and change content or a format of the prompt sentence for generation processing based on the acquired user attribute information or the user state information.

### (Supplementary 3)

The system according to supplementary 1,
wherein the processor is configured to
cause the generative AI model to generate explanation information or summary information based on the prompt sentence for generation processing, and sequentially distribute the generated explanation information or the summary information based on the time information.

### Application Example 2

### (Supplementary 1)

A system comprising a processor,
wherein the processor is configured to
acquire image information relating to a sports event, extract sound information from the image information, and convert the sound information into character information by using a speech recognition technique,
perform signal processing on the sound information to detect a rapid change in sound volume exceeding a predetermined threshold based on a temporal change of the sound volume, and
specify time information corresponding to the detected rapid change in sound volume as a highlight section of a game,
acquire game-related information including score information, group information, and participant information from an external information providing apparatus, and manage the game-related information in association with the time information,
estimate an emotional state of a user based on voice information and image information acquired from a user terminal, and record the emotional state as an emotion label in association with time information,
construct a prompt sentence as an input sentence for a generative AI model on the basis of the time information corresponding to the highlight section, the game-related information, and the emotion label, and create generation instruction information for using the prompt sentence as input to the generative AI model, and
input the prompt sentence to the generative AI model so as to cause the generative AI model to generate text data for an information sharing service, and transmit the text data to a terminal device as notification data or subtitle data.

### (Supplementary 2)

The system according to supplementary 1,
wherein the processor is configured to preprocess the voice information and the image information acquired from the user terminal, extract feature quantities, estimate the emotional state based on the feature quantities, and control at least one of a style, a tone, and an amount of information of the prompt sentence according to the emotional state in the generation instruction information.

### (Supplementary 3)

The system according to supplementary 1,
wherein the processor is configured to extract, from the text data, highlight information corresponding to the highlight section, generate in real time a notification message including the highlight information, append the time information to the notification message, transmit the notification message to the terminal device, and cause the terminal device to start playback of the image information relating to the sports event from a time corresponding to the time information.

What is claimed is:

1. A system comprising:
circuitry configured to:
receive, via a communication interface coupled to a packet-switched network, a video input signal comprising broadcast video data, and separate an audio signal from the video input signal to generate audio data;
execute speech recognition processing on the audio data to generate character information associated with time information, and calculate a temporal change of an acoustic quantity based on the audio data;
detect a change of the acoustic quantity satisfying a predetermined condition to specify time information of an excitement event, and acquire event information, group information, and participant information from an external data source;
associate the acquired event information, group information, and participant information with the time information and the character information to generate structured data, and generate a prompt sentence based on the structured data, the prompt sentence including instructions relating to an event situation, an event content, and an output format;
execute inference processing using a generative neural network model with the prompt sentence as input to generate a natural language document, and record the natural language document as related information in association with the time information of the excitement event; and
synchronize the natural language document with the time information, superimpose the natural language document on distribution data, and continuously distribute the broadcast video data together with the related information to a terminal device via the communication interface.

2. The system according to claim 1, wherein the circuitry is configured to calculate the acoustic quantity as at least one of a volume level in a time domain and a spectral energy value in a frequency domain of the audio data.

3. The system according to claim 2, wherein the circuitry is configured to detect the change of the acoustic quantity satisfying the predetermined condition by comparing the acoustic quantity to a threshold value, and identify the time information of the excitement event based on a time point at which the threshold value is exceeded.

4. The system according to claim 3, wherein the circuitry is configured to classify the excitement event based on the character information and the acoustic quantity change, and select an output format instruction in the prompt sentence corresponding to the classified event type.

5. The system according to claim 4, wherein the circuitry is configured to generate the prompt sentence by embedding at least event type information, participant attribute information, and a temporal context window associated with the time information into a natural language template.

6. The system according to claim 5, wherein the circuitry is configured to update the prompt sentence with additional contextual data acquired from the external data source, including at least one of score information and statistical performance information.

7. The system according to claim 1, wherein the circuitry is configured to estimate an affective state of a user based on operation information received from the terminal device, and change at least one of an instruction content and a style condition included in the prompt sentence in accordance with the estimated affective state.

8. The system according to claim 7, wherein the circuitry is configured to adjust at least one of a writing style parameter and a content emphasis parameter in the prompt sentence based on the estimated affective state, to generate a natural language document adapted to the affective state of the user.

9. The system according to claim 1, wherein the circuitry is configured to associate the recorded natural language document with a corresponding section of the broadcast video data, and provide the terminal device with index data enabling playback control based on the time information.

10. The system according to claim 9, wherein the circuitry is configured to transmit the natural language document to the terminal device in real time synchronized with the time information of the excitement event for display during playback of the broadcast video data.

11. The system according to claim 1, wherein the circuitry is configured to perform the speech recognition processing using a speech recognition model to convert the audio data into a text sequence, and associate text segments with corresponding time stamps to generate the character information with time information.

12. The system according to claim 11, wherein the circuitry is configured to segment the text sequence into event-relevant units based on the time information of the excitement event, and incorporate the segmented units into the structured data.

13. The system according to claim 1, wherein the circuitry is configured to store the generated prompt sentence and the natural language document as log information in a storage device, and update generation conditions for subsequent prompt sentences based on the stored log information.

14. The system according to claim 13, wherein the circuitry is configured to retrieve stored log information entries having high relevance to a current excitement event based on a similarity measure, and incorporate retrieved entries into a subsequent prompt sentence.

15. The system according to claim 1, wherein the circuitry is configured to encode the structured data as a vector representation, and compute a similarity score between the vector representation and stored record information to select relevant prior natural language documents for incorporation into the prompt sentence.

16. The system according to claim 15, wherein the circuitry is configured to retrieve prior natural language documents having similarity scores exceeding a threshold value and include a representation of the retrieved documents in the prompt sentence as context data.

17. The system according to claim 1, wherein the circuitry is configured to format the related information for presentation on the terminal device as overlay data superimposed on the broadcast video data during live distribution.

18. A system comprising:
circuitry configured to:
receive, via a communication interface coupled to a packet-switched network, a video input signal, and separate an audio signal from the video input signal to generate audio data;
execute speech recognition processing on the audio data using a speech recognition model to generate character information associated with time stamps, and calculate a temporal change of an acoustic quantity in at least one of a time domain and a frequency domain;
detect a change of the acoustic quantity exceeding a threshold value to specify time information of an excitement event, and acquire event information and participant information from an external data source;
generate structured data by associating the event information, the participant information, and the time information with the character information, construct a prompt sentence embedding event type information, participant attribute information, and a temporal context window, and execute inference processing using a generative neural network model to generate a natural language document; and
synchronize the natural language document with the time information of the excitement event, superimpose the natural language document on distribution data, and transmit the distribution data together with the natural language document to the terminal device via the communication interface.

19. The system according to claim 18, wherein the circuitry is configured to estimate an affective state of a user from operation information received from the terminal device, and adjust at least one of a writing style parameter and an instruction content parameter in the prompt sentence based on the estimated affective state.

20. A method comprising:
receiving, via a communication interface coupled to a packet-switched network, a video input signal comprising broadcast video data, and separating an audio signal from the video input signal to generate audio data;
executing speech recognition processing on the audio data to generate character information associated with time information, and calculating a temporal change of an acoustic quantity based on the audio data;
detecting a change of the acoustic quantity satisfying a predetermined condition to specify time information of an excitement event, and acquiring event information, group information, and participant information from an external data source;
associating the acquired event information, group information, and participant information with the time information and the character information to generate structured data, and generating a prompt sentence based on the structured data;
executing inference processing using a generative neural network model with the prompt sentence as input to generate a natural language document, and recording the natural language document as related information in association with the time information of the excitement event; and
synchronizing the natural language document with the time information, superimposing the natural language document on distribution data, and continuously distributing the broadcast video data together with the related information to a terminal device via the communication interface.
